(19) United States
(12) Patent Application Publication
(10) Pub. No.: US 2026/0027525 A1
(43) Pub. Date: Jan. 29, 2026

(54) Scalable Aqueous-Phase Fabrication Of Reduced Graphene Oxide Nanofiltration Membranes By An Integrated Roll-To-Roll (R2R) Process

(71) Applicant: Georgia Tech Research Corporation, Atlanta, GA (US)

(72) Inventors: Tequila A. L. Harris, Atlanta, GA (US); Amirsalar Esfahani, Atlanta, GA (US); Sankar Nair, Atlanta, GA (US)

(21) Appl. No.: 19/143,870

(22) PCT Filed: Dec. 29, 2023
(86) PCT No.: PCT/US2023/086384

§ 371 Date: Jun. 26, 2025

Related U.S. Application Data
(60) Provisional application No. 63/477,844, filed on Dec. 30, 2022.

(51) Int. Cl. B01D 71/02; B01D 61/02; B01D 67/00; B01D 69/10

(52) U.S. Cl. CPC B01D 71/0211; B01D 61/027; B01D 67/0039; B01D 69/10; B01D 2323/10; B01D 2325/04

(57) ABSTRACT

A scaled fabrication of graphene oxide (GO) nano filtration membranes by slot-die coating on a roll-to-roll (R2R) with CN integrated vacuum filtration, and reduced-GO membranes “R2R-rGO membranes” formed therefrom.

### CROSS-REFERENCE TO RELATED APPLICATIONS

This Application claims the benefit of U.S. Provisional Application Ser. No. 63/477,844 filed 30 Dec. 2022, the entire contents and substance of which are incorporated herein by reference in their entirety as if fully set forth below.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The present invention relates generally to separation technologies, and more particularly to the fabrication of membranes useful for the fractionation of multicomponent streams, and reduced graphene oxide nanofiltration membranes fabricated by an integrated roll-to-roll process.

### 2. Description of Related Art

There is an increasing demand in many industrial sectors for large-scale separation of complex aqueous streams to produce usable water, simultaneously recover/concentrate valuable resources (such as biomass components, salts, metals), and save energy relative to conventional separation processes such as distillation or liquid extraction. See, for example, [1] J. M. Dickhout, J. Moreno, P. M. Biesheuvel, L. Boels, R. G. H. Lammertink, W. M. de Vos, Produced Water Treatment By Membranes: A Review From A Colloidal Perspective, Journal of Colloid and Interface Science, Volume 487, (2017), Pages 523-534, ISSN 0021-9797, https://doi.org/10.1016/j.jcis.2016.10.013; [2] E. Kavitha, E. Poonguzhali, D. Nanditha, Ashish Kapoor, G. Arthanareeswaran, S. Prabhakar, Current Status And Future Prospects Of Membrane Separation Processes For Value Recovery From Wastewater, Chemosphere, Volume 291, Part 2, (2022), 132690, ISSN 0045-6535, https://doi.org/10.1016/j.chemosphere.2021.132690; [3] Wichitpan Rongwong, Kunli Goh, Resource Recovery From Industrial Wastewaters By Hydrophobic Membrane Contactors: A Review, Journal of Environmental Chemical Engineering, Volume 8, Issue 5, (2020), 104242, ISSN 2213-3437, https://doi.org/10.1016/j.jece.2020.104242; and [4] Vinod Kumar, Sudesh K. Yadav, Jitendra Kumar, Vivek Ahluwalia, A Critical Review On Current Strategies And Trends Employed For Removal Of Inhibitors And Toxic Materials Generated During Biomass Pretreatment, Bioresource Technology, Volume 299, (2020), 122633, ISSN 0960-8524, https://doi.org/10.1016/j.bioitech.2019.122633.

Nanofiltration (NF) membranes are considered a key technological element in such processes.

While polymeric membranes have so far dominated NF applications, there are many emerging separation problems in which polymeric membranes cannot provide the desired combination of performance and stability. Such problems typically involve elevated temperatures, pH extremes, and high dissolved solids content. See, for example, [5] David M. Warsinger, Sudip Chakraborty, Emily W. Tow, Megan H. Plumlee, Christopher Bellona, Savvina Loutatidou, Leila Karimi, Anne M. Mikelonis, Andrea Achilli, Abbas Ghassemi, Lokesh P. Padhye, Shane A. Snyder, Stefano Curcio, Chad D. Vecitis, Hassan A. Arafat, John H. Lienhard, A Review Of Polymeric Membranes And Processes For Potable Water Reuse, Progress in Polymer Science, Volume 81, (2018), Pages 209-237, ISSN 0079-6700, https://doi.org/10.1016/j.prog2polymsci.2018.01.004; and [6] Milad Rabbani Esfahani, Sadegh Aghapour Aktij, Zoheir Dabaghian, Mostafa Dadashi Firouzjaei, Ahmad Rahimpour, Joyner Eke, Isabel C. Escobar, Mojtaba Abolhassani, Lauren F. Greenlee, Amirsalar R. Esfahani, Anwar Sadmani, Negin Koutahzadeh, Nanocomposite Membranes For Water Separation And Purification: Fabrication, Modification, And Applications, Separation and Purification Technology, Volume 213, (2019), Pages 465-499, ISSN 1383-5866, https://doi.org/10.1016/j.seppur.2018.12.050.

A particular example is in the conversion of forest biomass by the kraft process. See, for example, [7] Jobien Laurijssen, André Faaij, Ernst Worrell, Energy Conversion Strategies In The European Paper Industry—A Case Study In Three Countries, Applied Energy, Volume 98, (2012), Pages 102-113, ISSN 0306-2619, https://doi.org/10.1016/j.apenergy.2012.03.001.

Black liquor (BL) is an aqueous waste product of the kraft papermaking process. A typical papermaking facility produces about 500 gal/min of weak black liquor (WBL), which generally comprises about 15 wt % of solids. The solids typically include lignin, hemicellulose, and inorganic chemicals suspended or dissolved in water, and the WBL solution typically has a pH of about 13 and is typically discharged having a temperature of about 700° C. to about 950° C. Conventionally, WBL is concentrated to strong black liquor (SBL), which generally comprises about 65 wt % to about 80 wt % of solids, via six-stage multiple-effect evaporators, and the SBL can be burned in a recovery boiler to produce energy.

For every ton of cellulose pulp produced, about six tons of BL byproduct is generated. BL is generated at about 1 billion tons/year in pulp and paper mills, and is a complex stream at:
high alkaline pH (˜13)—see, for example, [8] Runyu Wang, Roger Deplazes, Frédéric Vogel, and David Baudouin, Continuous Extraction Of Black Liquor Salts Under Hydrothermal Conditions, Industrial & Engineering Chemistry Research, Volume 60, Issue 10, (2021), Pages 4072-4085, https://doi.org/10.1021/acs.iecr.0c05203; and [9] Héléne Boucard, Masaru Watanabe, Seiichi Takami, Elsa Weiss-Hortala, Radu Barna, Tadafumi Adschiri, Beneficial Use Of CeO2 Nanocatalyst For Black Liquor Conversion Under Sub And Supercritical Conditions, The Journal of Supercritical Fluids, Volume 105, (2015), Pages 66-76, ISSN 0896-8446, https://doi.org/10.1016/supflu.2015.02.008;
high temperature (70-95° C.)—see, for example, [10] Niklas Berglin, Hikan Eriksson, Thore Berntsson, Performance Evaluation Of Competing Designs For Efficient Cogeneration From Black Liquor, Proceedings, 2nd Biennial Johan Gullichsen Colloquium, Helsinki, Finland, Sep. 9-10, 1999); and [11] M. Naqvi, J. Yan, E. Dahlquist, Black Liquor Gasification Integrated In Pulp And Paper Mills: A Critical Review, Bioresource Technology, Volume 101, Issue 21, 2010, Pages 8001-8015, ISSN 0960-8524, https://doi.org/10.1016/j.biortech.2010.05.013; and
high dissolved solids content (15 wt % total solids, including lignin, other organics, and inorganic salts)—see, for example, [12] Pratima Bajpai, Biermann's Handbook of Pulp and Paper, Volume 1: Raw Material and Pulp Making, Elsevier, (2018), https://doi.org/10.1016/C2017-0-00513-X; and [13] Ayhan Demirbaş, Pyrolysis And Steam Gasification Processes Of Black Liquor, Energy Conversion and Management, Volume 43, Issue 7, (2002), Pages 877-884, ISSN 0196-8904, https://doi.org/10.1016/S0196-8904(01)00087-5.

In current kraft processes, BL is dewatered to 75-80 wt % solids by multi-effect evaporators), which is a highly energy intensive process. See, for example, [14] Arif Darmawan, Flabianus Hardi, Kunio Yoshikawa, Muhammad Aziz, Koji Tokimatsu, Enhanced Process Integration Of Black Liquor Evaporation, Gasification, And Combined Cycle, Applied Energy, Volume 204, (2017), Pages 1035-1042, ISSN 0306-2619, https://doi.org/10.1016/j.apenergy.2017.05.058.

Using NF membranes to concentrate BL from 15 wt % to about 30 wt % solids can allow the removal of more than 50% water from BL without the use of evaporation. See, for example, [15] Zhongzhen Wang, Chen Ma, Alice Shen, Amiel Berchenko, Scott A. Sinquefield, Sankar Nair, Kraft Black Liquor Concentration With Graphene Oxide Membranes: Process Simulations And Technoeconomic Analysis, J. Adv. Manuf. Process, (2021), 3(4), e10104, https://doi.org/10.1002/amp2.10104.

The BL concentration process can be highly energy-intensive. The amount of energy required by this process may be reduced by introducing a separating process to the WBL, such as a membrane-based separation. Existing membranes, however, typically have a short working life due to the extreme alkaline pH and temperature typical of BL streams, are prohibitively expensive, and/or are unable to operate at a sufficient flux or sufficient efficiency of lignin rejection for industrial application. For example, polymer membranes generally have short lifetimes, are subject to fouling, and are expensive. Also, ceramic membranes, which may provide greater resilience than polymer membranes, are generally prohibitively expensive.

While polymeric membranes cannot provide the required performance and stability in this demanding application, recent work on reduced graphene oxide (rGO) NF membranes supported on polyethersulfone (PES) has shown favorable performance in terms of their lignin rejection, flux, and stability in BL conditions. See, for example [15]; [16] Fereshteh Rashidi, Nikita S. Kevlich, Scott A. Sinquefield, Meisha L. Shofner, Sankar Nair, Graphene Oxide Membranes In Extreme Operating Environments: Concentration Of Kraft Black Liquor By Lignin Retention, ACS Sustainable Chem. Eng., (2017), 5, 1, 1002-1009, https://doi.org/10.1021/acssuscheneng,6b02321; and [17] Zhongzhen Wang, Chen Ma, Scott A. Sinquefield, Meisha L. Shofner, Sankar Nair, High-Performance Graphene Oxide Nanofiltration Membranes For Black Liquor Concentration, ACS Sustainable Chem. Eng., (2019), 7, 17, 14915-14923, https://doi.org/10.1021/acssuschemeng.9b03113.

These performance parameters allow integration of rGO NF membranes into modified kraft process designs, in which membranes can concentrate BL and produce process-quality (i.e., reusable in the kraft process) water in an economical manner [15].

To enable the eventual deployment of GO membranes, scalable fabrication methodologies are necessary. Scaled fabrication of polymeric NF membranes by various kinds of organic solvent-based phase separation techniques is now well known. See, for example [6]; [18] Dooli Kim, Suzana P. Nunes, Green Solvents For Membrane Manufacture: Recent Trends And Perspectives, Current Opinion in Green and Sustainable Chemistry, Volume 28, (2021), 100427, ISSN 2452-2236, https://doi.org/10.1016/j.cogsc.2020.100427; [19] Gui Min Shi, Yingnan Feng, Bofan Li, Hui Min Tham, Juin-Yih Lai, Tai-Shung Chung, Recent Progress Of Organic Solvent Nanofiltration Membranes, Progress in Polymer Science, Volume 123, (2021), 101470, ISSN 0079-6700, https://doi.org/10.1016/j.progpolymsci.2021.101470; and [20] Zhuyuan Wang, Songmiao Liang, Yuan Kang, Wang Zhao, Yun Xia, Jindi Yang, Huanting Wang, Xiwang Zhang, Manipulating Interfacial Polymerization For Polymeric Nanofilms Of Composite Separation Membranes, Progress in Polymer Science, Volume 122, (2021), 101450, ISSN 0079-6700, https://doi.org/10.1016/j.progpolvmsci.2021.101450.

Yet GO membranes present very different fabrication challenges from polymeric NF membranes since they are 2D nanosheet-like materials. On a laboratory scale, GO membranes have been fabricated by a variety of techniques such as:
spin coating—see, for example, [21] Shingjiang Jessie Lue, Yu-Li Pai, Chao-Ming Shih, Ming-Chung Wu, Sun-Mou Lai, Novel Bilayer Well-Aligned Nafion/Graphene Oxide Composite Membranes Prepared Using Spin Coating Method For Direct Liquid Fuel Cells, Journal of Membrane Science, Volume 493, (2015), Pages 212-223, ISSN 0376-7388, https://doi.org/10.1016/j.memsci.2015.07.007; and [22] Jen-Yu Lee, Jin-Yun Zhan, Micah Belle Marie Yap Ang, Shih-Chieh Yeh, Hui-An Tsai, Ru-Jong Jeng, Improved Performance Of Nanocomposite Polyimide Membranes For Pervaporation Fabricated By Embedding Spirobisindane Structure-Functionalized Graphene Oxide, Separation and Purification Technology, Volume 265, (2021), 118470, ISSN 1383-5866, https://doi.org/10.1016/j.seppur.2021.118470;
doctor blade casting—see, for example, [23] Euntae Yang, H. Enis Karahan, Kunli Goh, Chong Yang Chuah, Rong Wang, Tae-Hyun Bae, Scalable Fabrication Of Graphene—Based Laminate Membranes For Liquid And Gas Separations By Crosslinking-Induced Gelation And Doctor-Blade Casting, Carbon, Volume 155, (2019), Pages 129-137, ISSN 0008-6223, https://doi.org/10.1016/j.carbon.2019.08.058; and [24] Brian McVerry, Mackenzie Anderson, Na He, Hyukmin Kweon, Chenhao Ji, Shuangmei Xue, Ethan Rao, Chain Lee, Cheng-Wei Lin, Dayong Chen, Dukwoo Jun, Gaurav Sant, Richard B. Kaner, Next-Generation Asymmetric Membranes Using Thin-Film Liftoff, Nano Lett., (2019), 19, 8, 5036-5043, https://doi.org/10.1021/acs.nanolett.9b01289; and
vacuum filtration—see, for example, [25] Hsin-Hui Huang, Rakesh K. Joshi, K. Kanishka H. De Silva, Rajashekar Badam, Masamichi Yoshimura, Fabrication Of Reduced Graphene Oxide Membranes For Water Desalination, Journal of Membrane Science, Volume 572, (2019), Pages 12-19, ISSN 0376-7388, https://doi.org/10.1016/j.memsci.2018.10.085; and [26]Chenglong Chi, Xuerui Wang, Yongwu Peng, Yuhong Qian, Zhigang Hu, Jingiao Dong, Dan Zhao, Facile Preparation Of Graphene Oxide Membranes For Gas Separation, Chem. Mater., (2016), 28, 9, 2921-2927, https://doi.org/10.1021/acs.chemmater.5b04475.

Yet none of these methods are suited for large-scale fabrication.

However, slot-die coating methods can enable continuous fabrication. See, for example, [27] Adam Phillips, M Ulsh, Jocelyn Mackay, Tequila Harris, Naveen Shrivastava, Abheek Chatterjee, Jason Porter, Guido Bender, (2020), The Effect OfMembrane Casting Irregularities On Initial Fuel Cell Performance, Fuel Cells, 20: 60-69, https://doi.org/10.1002/fuce.201900149; [28] Sneha Chede, Nelson M. Anaya, Vinka Oyanedel-Craver, Sanam Gorgannejad, Tequila A. L. Harris, Jumana Al-Mallahi, Muna Abu-Dalo, Hani Abu Qdais, Isabel C. Escobar, Desalination Using Low Biofouling Nanocomposite Membranes: From Batch-Scale To Continuous-Scale Membrane Fabrication, Desalination, Volume 451, (2019), Pages 81-91, ISSN 0011-9164, https://doi.org/10.1016/j.desal.2017.05.007; and [29] Xiao Wang, Dufei Fang, Benjamin S. Hsiao, Benjamin Chu, Nanofiltration Membranes Based On Thin-Film Nanofibrous Composites, Journal of Membrane Science, Volume 469, (2014), Pages 188-197, ISSN 0376-7388, https://doi.org/10.1016/j.memsci.2014.06.049.

Recently, this method has been studied for GO membrane fabrication to produce membranes with sizes up to 15 cm, using volatile organic solvents to suspend the GO nanosheets prior to deposition. See, for example, [30] Ji Hoon Kim, Yunkyu Choi, Junhyeok Kang, Eunji Choi, Seung Eun Choi, Ohchan Kwon, Dae Woo Kim, Scalable Fabrication Of Deoxygenated Graphene Oxide Nanofiltration Membrane By Continuous Slot-Die Coating, Journal of Membrane Science, Volume 612, (2020), 118454, ISSN 0376-7388, https://doi.org/10.1016/j.memsci.2020.118454; and [31] Ji Hoon Kim, Yunkyu Choi, Junhyeok Kang, Ju Yeon Kim, Jun Hyuk Bae, Ohchan Kwon, Dae Woo Kim, Shear-Induced Assembly Of High-Aspect-Ratio Graphene Nanoribbon Nanosheets In A Confined Microchannel: Membrane Fabrication For Ultrafast Organic Solvent Nanofiltration, Carbon, Volume 191, (2022), Pages 563-570, ISSN 0008-6223, https://doi.org/10.1016/j.carbon.2022.02.026.

In a previous work, [32] Zhongzhen Wang, Chen Ma, Chunyan Xu, Scott A. Sinquefield, Meisha L. Shofner, Sankar Nair, Graphene Oxide Nanofiltration Membranes For Desalination Under Realistic Conditions, Nat Sustain 4, 402-408 (2021), https://doi.org/10.1038/s41893-020-00674-3, it was demonstrated that the fabrication of large-area rGO membranes (supported on PES) by vacuum filtration in static batch mode. Both circular (1 foot diameter) [17] and rectangular (4′×1′) [32] flat sheets were produced, and showed reliable performance in crossflow NF with BL feed streams.

It is thus clear that solutions to provide economical fractionation of multicomponent biomass-derived streams for in the production of biobased fuels and chemicals are needed. As noted, kraft BL is generated at ˜1 billion tons/yr globally from biomass pulping and contains ˜15 wt % total solids including lignin, hemicellulose fragments, and inorganics. Membrane-based BL concentration is attractive, but challenged by low solute rejections and poor stability in BL, which combines alkaline pH (˜13), high dissolved solids content (15+wt %) and high temperature (70-85° C.).

Thus, there is a need for improved systems and methods for the large-scale separation of complex aqueous streams to produce usable water, simultaneously recover/concentrate valuable resources (such as biomass components, salts, metals), while saving energy relative to conventional separation processes such as distillation or liquid extraction. To proceed towards such further scale-up to full-size modules and eventual deployment, there is a need for reliable, low-cost, and environmentally benign dynamic fabrication processes amenable to roll-to-roll (R2R) for GO-based membranes. Examples of the present disclosure are directed to these and other considerations.

### SUMMARY OF THE INVENTION

An exemplary embodiment of the present invention comprises a method of fabricating a membrane that can successfully fraction multicomponent streams. In any of the disclosed embodiments, the fabricated membrane can be used with kraft black liquor (BL) containing ˜15 wt % total solids, including lignin, hemicellulose fragments, and inorganics. In any of the disclosed embodiments, robust graphene oxide (GO) membranes for kraft processing are formed with a scaled-up fabrication by a dynamic/roll-to-roll (R2R) process integrated with vacuum filtration.

In any of the disclosed embodiments, the process uses only aqueous suspensions, and no organic chemicals. The fabricated reduced GO (rGO) membranes and rGO-X membranes, in which X=a large pi-conjugated polyaromatic species that binds strongly to the rGO sheets and dramatically changes its characteristics.

Key dynamic processing factors assist in determining the quality of the R2R membranes, and then those factors are optimized for the R2R process on sheet sizes up to 3 ft (L)×1 ft (W). In any of the disclosed embodiments, “defect-free” GO membranes with thicknesses the range of 100-200 nm are fabricated.

In any of the disclosed embodiments, the resulting membranes retain the key advantage of GO: high water flux and excellent stability in alkali and high-solids environments.

In any of the disclosed embodiments, the present invention is an organic solvent/VOC-free R2R process compatible with a wide variety of polymeric support materials.

Another exemplary embodiment of the present invention comprises the R2R fabrication of GO membranes by aqueous phase processing under vacuum conditions that enables membrane manufacturing without organic solvents and volatile organic compounds (VOCs). This allows more environmentally friendly and much cheaper fabrication, and allows compatibility with many types of substrate materials which may not be amenable to processing in organic solvents.

Another exemplary embodiment of the present invention comprises a scaled fabrication and characterization of nanofiltration (NF) membranes by slot-die coating on a R2R with integrated vacuum filtration.

In any of the disclosed embodiments, the NF membrane can be configured to remove lignin from black liquor. The NF membrane can comprise a carbon-based nanomaterial (CBN) membrane and a porous substrate covered by the CBN.

In any of the disclosed embodiments, the CBN can be selected from the group consisting of graphene oxide (GO), reduced graphene oxide (rGO), holey graphene oxide (hGO), and a combination thereof.

Another exemplary embodiment of the present invention comprises a method of fabricating a CBN suspension membrane comprising coating, with a coater, a CBN suspension on a porous substrate, and vacuum processing, with a vacuum, the CBN suspension and the porous substrate, wherein the fabricating comprises a completely aqueous-phase continuous fabricating.

In any of the disclosed embodiments, relative motion between the coater, the porous substrate, and the vacuum provide for forming a continuous feed of a CBN membrane by a continuous coating of the CBN suspension on the porous substrate and the vacuum processing of the CBN suspension and the porous substrate.

In any of the disclosed embodiments, at least one of the coating, the porous substrate, or the vacuum processing is stationary.

In any of the disclosed embodiments, the CBN suspension is free of organic solvents and VOCs.

In any of the disclosed embodiments, the method can further comprise continuously supplying a carrier in a R2R manner, and forming a continuous feed of a CBN membrane comprising the porous substrate and the coated CBN suspension in a form of a non-crosslinked CBN coating formed with vacuum assist from the vacuum processing, wherein the coating comprises slot-die coating the CBN suspension having a CBN suspension concentration across a coating gap and at a CBN suspension flow rate on a top surface of a porous substrate.

In any of the disclosed embodiments, the CBN membrane has a CBN membrane effective area of greater than 645 mm².

In any of the disclosed embodiments, the CBN membrane has a CBN membrane thickness of between 10 nm and 1000 nm.

In any of the disclosed embodiments, the CBN membrane has a CBN membrane defect profile of nonuniformity in a thickness direction of less than 10%.

In any of the disclosed embodiments, the CBN membrane has a CBN membrane defect profile of a delamination of less than 10%.

In any of the disclosed embodiments, the CBN membrane has a CBN membrane defect profile of streaks or rivulets of less than 10%.

In any of the disclosed embodiments, the CBN membrane has a CBN membrane defect profile of an air entrainment of less than 10%.

In any of the disclosed embodiments, the CBN membrane has a CBN membrane defect profile of ribbing or waviness in a machine direction web that do not break through to the porous substrate of less than 10%.

In any of the disclosed embodiments, the CBN membrane has a CBN membrane defect profile of barring or waviness across a machine direction web of the porous substrate of less than 10%.

In any of the disclosed embodiments, the CBN membrane is formed in the size of 90×30 cm and has effective area of 2700 cm². The present invention obtains high-quality reduced-GO membranes (“R2R-rGO membranes”) with ˜100 nm average thickness supported on porous poly(ethersulfone) (PES) sheets.

Another exemplary embodiment of the present invention comprises a scaled fabrication and characterization of GO NF membranes by slot-die coating on a R2R with integrated vacuum filtration in the size of 90×30 cm and effective area of 2700 cm². The present invention obtains high-quality reduced-GO membranes (“R2R-rGO membranes”) with ˜100 nm average thickness supported on porous poly(ethersulfone) (PES) sheets.

In any of the disclosed embodiments, the present invention can comprise aqueous-phase R2R vacuum processing of GO and modified-GO membranes. In any of the disclosed embodiments, the fabrication can be an organic solvent/VOC-free R2R process compatible with a wide variety of polymeric support materials.

In any of the disclosed embodiments, the present GO membrane technology involves only aqueous-phase processing: no covalent crosslinking.

In any of the disclosed embodiments, the resulting membranes retain key advantage of GO: high water flux and excellent stability in alkali and high-solids environments.

Another exemplary embodiment of the present invention comprises R2R fabrication and the characterization of reduced GO (rGO) NF membranes on PES substrate sheets integrated with vacuum filtration. This customized R2R process uses only aqueous suspensions and does not involve the use of any organic solvents, VOCs, or crosslinking agents.

Another exemplary embodiment of the present invention comprises a method of GO membrane fabrication comprising slot-die coating a GO suspension on a porous substrate and vacuum processing the GO suspension and the substrate.

In any of the disclosed embodiments, the GO suspension can be an aqueous GO suspension. In any of the disclosed embodiments, the GO suspension can be free of organic solvents and VOCs.

In any of the disclosed embodiments, the fabrication can be a completely aqueous-phase continuous fabrication. In any of the disclosed embodiments, the fabrication can be a continuous fabrication free of organic solvents and VOCs.

In any of the disclosed embodiments, the method can further comprise moving the substrate in a substrate direction at a substrate speed.

In any of the disclosed embodiments, the slot-die coating can comprise applying the GO suspension across a coating gap and at a GO suspension flow rate on a top surface of the substrate, and wherein the GO suspension has a GO suspension concentration.

In any of the disclosed embodiments, the vacuum processing can comprise applying a vacuum through the substrate to fabricate a GO membrane from the vacuumed GO suspension and the substrate.

In any of the disclosed embodiments, the vacuum processing can comprise applying a vacuum with a vacuum assembly upon which a bottom surface of the substrate is supported, and moving a carrier upon which the vacuum assembly is carried such that the vacuum supported substrate moves in a substrate direction at a substrate speed.

In any of the disclosed embodiments, the method can further comprise forming a GO membrane from the vacuumed GO suspension and the substrate, wherein the GO membrane has a GO membrane effective area, a GO membrane thickness, and a GO membrane defect profile.

Exemplary R2R-rGO membranes fabricated by the innovative processes show >98% lignin rejection with a steady state flux of ˜12 liters of permeate per square meter of membrane area per hour (LMH) at 50 bar in a 15.7 wt % total solids (TS) kraft BL stream at 720° C. and 2-3 gal/min crossflow rates. Slot-die coating on a R2R platform with integrated vacuum filtration can thus enable rapid fabrication of high-quality GO membranes at scale without the use of organic solvents or VOCs.

Key dynamic processing factors are examined that determine the quality of R2R-rGO membranes coated with a slot-die. The resulting R2R-rGO membranes, with thicknesses in the nominal range of 100-200 nm, show excellent chemical and mechanical stability under high pressure and temperature conditions, equivalent to the static batch mode processed membranes. Separation data indicates that the present R2R-rGO membranes have equivalent/identical performance in kraft BL processing to that of static batch mode processed rGO membranes. These results have strong positive implications for the industrial application of GO-based membranes in BL concentration and other related uses in biorefining.

Main coating factors include fluid concentration (mg/mL), fluid flow rate/pump rate (m/min) and casting speed/substrate speed (mm/s). Various combinations of R2R coating parameters with the fluid comprising rGO and the substrate comprising PES, included fluid concentrations of 0.25, 0.5, 1.0, 2.0, 2.0, 2.0, 2.0, 3.0, 4.0, and 4.0 mg/mL, attendant casting speeds of 5.4, 5.4, 5.4, 5.4, 4.2, 3.0, 3.0, 3.0, 5.4, and 3.0 mm/s, attendant fluid flow rates of 3, 3, 3, 3, 2, 2, 1.5, 2, 2, and 2 mL/min, and attendant required GO/rGO volumes (mL) of 2.8, 2.8, 2.8, 2.8, 3.0, 4.1, 3.1, 4.1, 2.3, and 4.1 mL, and attendant projected thickness (nm) of 7.6, 15.2, 30.4, 60.8, 51.7, 71.8, 53.9, 107.8, 81, and 144 nm. For each sample, the membrane area was 0.1 m², the density adjustment parameter was 0.5, and the rGO density was 2000 kg/m³. The projected thickness was calculated based on a formula of

Projected Thickness=rGO Volume*rGO Concentraion*1000/Membrane Area*rGO Density*Density Adjustment Parameter

Another exemplary embodiment of the present invention comprises a system for GO membrane fabrication comprising a porous substrate configured to move in a substrate direction at a substrate speed, a slot-die coater configured to apply a GO suspension across a coating gap and at a GO suspension flow rate on a top surface of the substrate, the GO suspension having a GO suspension concentration, a vacuum assembly upon which a bottom surface of the substrate is supported, the vacuum assembly configured to apply a vacuum to the substrate to vacuum secure the substrate to the vacuum assembly and fabricate a GO membrane from the GO suspension, and a moving carrier upon which the vacuum assembly is carried such that the vacuum secured membrane substrate moves in the substrate direction at the substrate speed, wherein the fabricated GO membrane has a GO membrane effective area, a GO membrane thickness, and a GO membrane defect profile.

In any of the disclosed embodiments, the defect profile can include a tolerance range of a defect characteristic selected from the group consisting of nonuniformity, delamination, streaks or rivulets, air entrainment, ribbing or waviness, barring or waviness, and combinations thereof.

An exemplary R2R-rGO membrane formed by the present invention comprises a substrate and a non-crosslinked GO coating layer covering the substrate. In some embodiments, the thickness of the GO coating layer may be less than or equal to about 300 nm. In certain embodiments, the d-spacing of the GO coating layer can be dimensioned such that the R2R-rGO membrane is configured to remove or reject lignin from BL. For example, in some embodiments, the R2R-rGO membrane may have a molecular weight cutoff from about 300 Daltons to about 1000 Daltons. Molecular weight cutoff refers to lowest molecular weight of a solute in which 90% of the solute is retained by a membrane. In some embodiments, the R2R-rGO membrane may have a molecular weight cutoff from about 300 Daltons to about 500 Daltons. In some embodiments, the R2R-rGO membrane may have a molecular weight cutoff from about 500 Daltons to about 1000 Daltons.

In certain embodiments, the GO coating layer of the R2R-rGO membrane may comprise pores in the range of about 3 angstroms to about 15 angstroms. In some embodiments, the GO coating layer may comprise pores in the range of about 7 angstroms to about 10 angstroms. In some embodiments, the GO coating layer may comprise pores in the range of about 3 angstroms to about 10 angstroms. Some embodiments may reject lignin at a rate greater than or equal to about 90%. For example, some embodiments may reject lignin at a rate of about 95% to about 99%.

The R2R-rGO membrane can be used for processing BL comprising removing from 90%-99% of lignin present in BL via filtering through the R2R-rGO membrane, wherein the BL has pre- and post-filtering properties including a pre-filtering total solids concentration of 10 wt %, a temperature of between about 70° C. and about 950° C., and a pH of about 13, and a post-filtering temperature of between about 70° C. and about 95° C. and a pH of about 13, wherein the GO coating layer shields the substrate from exposure to the BL, and wherein permeability of the GO coating layer as measured by water permeation flux as a function of transmembrane pressure does not decrease after flowing the BL through the R2R-rGO membrane.

The substrate has a thermal stability limit greater than the temperature of the BL and comprises a microporous polymer substrate comprising a polymer with aryl groups. The substrate can comprise at least one of poly(sulfone) and poly(ethersulfone).

Another exemplary embodiment of the present invention comprises a CBN suspension membrane fabricated by any of the methods disclosed herein.

Another exemplary embodiment of the present invention comprises a method of fabricating a CBN suspension membrane comprising slot-die coating a CBN suspension on a porous substrate, and vacuum processing the CBN suspension, one or more additives, and the porous substrate.

In any of the disclosed embodiments, the CBN suspension is an aqueous CBN suspension.

In any of the disclosed embodiments, the CBN is selected from the group consisting of GO, rGO, hGO, and a combination thereof.

In any of the disclosed embodiments, the CBN suspension is an aqueous CBN suspension comprising the one or more additives.

In any of the disclosed embodiments, the CBN suspension is free of organic solvents and VOCs.

In any of the disclosed embodiments, the fabricating comprises a completely aqueous-phase continuous fabricating.

In any of the disclosed embodiments, the fabricating is a continuous fabricating, free of organic solvents and VOCs.

In any of the disclosed embodiments, the method can further comprise continuously supplying a carrier in a R2R manner, and forming a continuous feed of a CBN membrane comprising the porous substrate and the coated CBN suspension in a form of a non-crosslinked CBN coating formed with vacuum assist from the vacuum processing, wherein the slot-die coating comprises slot-die coating the CBN suspension having a CBN suspension concentration across a coating gap and at a CBN suspension flow rate on a top surface of a porous substrate.

In any of the disclosed embodiments, the relative motion between the slot-die coating, the porous substrate, the carrier, and the vacuum processing provide for the forming of the continuous feed of the CBN membrane by a continuous slot-die coating of the CBN suspension on the porous substrate and the vacuum processing of the CBN suspension and the porous substrate.

In any of the disclosed embodiments, at least one of the coating, the porous substrate, the carrier, or the vacuum processing is stationary.

In any of the disclosed embodiments, the CBN membrane has a CBN membrane effective area of greater than 645 mm².

In any of the disclosed embodiments, the CBN membrane has a CBN membrane thickness of between 10 nm and 1000 nm.

In any of the disclosed embodiments, the CBN membrane has a CBN membrane defect profile of nonuniformity in a thickness direction of less than 10%.

In any of the disclosed embodiments, the CBN membrane has a CBN membrane defect profile of a delamination of less than 10%.

In any of the disclosed embodiments, the CBN membrane has a CBN membrane defect profile of streaks or rivulets of less than 10%.

In any of the disclosed embodiments, the CBN membrane has a CBN membrane defect profile of an air entrainment of less than 10%.

In any of the disclosed embodiments, the CBN membrane has a CBN membrane defect profile of ribbing or waviness in a machine direction web that do not break through to the porous substrate of less than 10%.

In any of the disclosed embodiments, the CBN membrane has a CBN membrane defect profile of barring or waviness across a machine direction web of the porous substrate of less than 10%.

Another exemplary embodiment of the present invention comprises a CBN suspension membrane fabricated by any of the methods disclosed herein.

Another exemplary embodiment of the present invention comprises a method of fabricating suspensions of GO or rGO into membranes comprising slot-die coating a GO or rGO suspension on a porous substrate, vacuum processing the GO or rGO suspension and the porous substrate, and forming a continuous feed of a GO or rGO membrane comprising the porous substrate and the coated GO or rGO suspension in a form of a non-crosslinked GO or rGO coating comprising one or more additives.

In any of the disclosed embodiments, the GO or rGO suspension comprises the one or more additives.

In any of the disclosed embodiments, the method can further comprise providing the one or more additives to the slot-die coated GO or rGO suspension on the porous substrate.

In any of the disclosed embodiments, the providing comprises slot-die coating the one or more additives to the slot-die coated GO or rGO suspension on the porous substrate.

In any of the disclosed embodiments, the GO or rGO suspension is an aqueous GO or rGO suspension free of organic solvents and VOCs, and the fabricating is a completely aqueous-phase continuous fabricating, free of organic solvents and VOCs.

In any of the disclosed embodiments, relative motion between the slot-die coating, the porous substrate, and the vacuum processing provide for the continuous slot-die coating of the GO or rGO suspension on the porous substrate and the vacuum processing the GO or rGO suspension and the porous substrate, and at least one of the slot-die coating, the porous substrate, or the vacuum processing is stationary.

In any of the disclosed embodiments, the fabricated GO or rGO membrane has a GO or rGO membrane effective area, a GO or rGO membrane thickness, and a GO or rGO membrane defect profile, the GO or rGO membrane effective area is greater than 645 mm, and wherein the GO or rGO membrane thickness is between 10 nm and 1000 nm.

In any of the disclosed embodiments, the GO or rGO membrane defect profile includes at least one defect characteristic selected from the group consisting of nonuniformity, delamination, streaks, rivulets, air entrainment, ribbing, barring, waviness, and combinations thereof, and the GO or rGO membrane has at least one of a nonuniformity defect characteristic in a thickness direction of less than 10%, a streaks or rivulets defect characteristic of less than 10%, an air entrainment defect characteristic of less than 10%, a ribbing or waviness defect characteristic in a machine direction web that do not break through to the porous substrate of less than 10%, a barring or waviness defect characteristic across a machine direction web of the porous substrate of less than 10%.

Another exemplary embodiment of the present invention comprises membranes fabricated by any of the methods disclosed herein.

Another exemplary embodiment of the present invention comprises a method of fabricating suspensions of GO or rGO into membranes comprising coating a GO or rGO suspension on a porous substrate, vacuum processing the GO or rGO suspension and the porous substrate, and forming a continuous feed of a GO or rGO membrane comprising the porous substrate and the coated GO or rGO suspension in a form of a non-crosslinked GO or rGO coating comprising one or more additives, wherein the fabricating comprises a completely aqueous-phase continuous fabricating.

In any of the disclosed embodiments, the coating is a unitary processing of the GO or rGO suspension and the one or more additives comprising slot-die coating, with a slot-die having a single head, the GO or rGO suspension comprising the one or more additives on the porous substrate.

In any of the disclosed embodiments, the coating is a co-processing of the GO or rGO suspension and the one or more additives comprising slot-die coating, from one of two tandem slot-dies of a slot-die, the GO or rGO suspension free of the one or more additives on the porous substrate, and slot-die coating, from the other of the two tandem slot-dies of the slot-die, the one or more additives on the porous substrate.

In any of the disclosed embodiments, the coating is a simultaneous processing of the GO or rGO suspension and the one or more additives comprising slot-die coating, from one layer of a dual layer slot-die, the GO or rGO suspension free of the one or more additives on the porous substrate, and slot-die coating, from the other layer of the dual layer slot-die, the one or more additives on the GO or rGO suspension.

Another exemplary embodiment of the present invention comprises a method of GO material membrane R2R fabrication comprising coating, with a coater, a GO material suspension on a porous substrate, and vacuum processing, with a vacuum, the GO material suspension and the porous substrate.

In any of the disclosed embodiments, the GO material is GO or rGO.

In any of the disclosed embodiments, the coating comprises slot-die coating the GO material suspension having a GO material suspension concentration across a coating gap and at a GO material suspension flow rate on a top surface of the porous substrate,

In any of the disclosed embodiments, the method can further comprise forming a continuous feed of a GO material membrane comprising the porous substrate and the coated GO material suspension in a form of a non-crosslinked GO material coating.

In any of the disclosed embodiments, the method can further comprise forming a continuous feed of a GO material membrane comprising the porous substrate and the coated GO material suspension in a form of a non-crosslinked GO material coating, wherein the GO material is GO or rGO, and wherein the coating comprises slot-die coating the GO material suspension having a GO material suspension concentration across a coating gap and at a GO material suspension flow rate on a top surface of the porous substrate.

In any of the disclosed embodiments, the GO material membrane has a GO material membrane effective area of greater than 645 mm².

In any of the disclosed embodiments, the GO material membrane has a GO material membrane thickness of between 10 nm and 1000 nm.

In any of the disclosed embodiments, the GO material membrane has a GO material membrane defect profile of nonuniformity in a thickness direction of less than 10%.

In any of the disclosed embodiments, the GO material membrane has a GO material membrane defect profile of a delamination of less than 10%.

In any of the disclosed embodiments, the GO material membrane has a GO material membrane defect profile of streaks or rivulets of less than 10%.

In any of the disclosed embodiments, the GO material membrane has a GO material membrane defect profile of an air entrainment of less than 10%.

In any of the disclosed embodiments, the GO material membrane has a GO material membrane defect profile of ribbing or waviness in a machine direction web that do not break through to the porous substrate of less than 10%.

In any of the disclosed embodiments, the GO material membrane has a GO material membrane defect profile of barring or waviness across a machine direction web of the porous substrate of less than 10%.

Another exemplary embodiment of the present invention comprises a GO material membrane fabricated by any of the methods disclosed herein.

Another exemplary embodiment of the present invention comprises a system for GO material membrane fabrication comprising a coater, a porous substrate, and a vacuum, wherein the coater is configured to coat a GO material suspension on the porous substrate, wherein the system is configured to fabricate a continuous feed of the GO material membrane comprising the porous substrate and the coated GO material suspension in a form of a non-crosslinked GO material coating formed with vacuum assist from the vacuum.

In any of the disclosed embodiments, the system is further configured for completely aqueous-phase continuous fabricating.

In any of the disclosed embodiments, relative motion between the coater and the porous substrate provide for a continuous coat of the GO material suspension on the porous substrate, the coater is a slot-die coater configured to apply the GO material suspension across a coating gap and at a GO material suspension flow rate on a top surface of the porous substrate, the GO material suspension having a GO material suspension concentration, and the vacuum supports a bottom surface of the porous substrate, the vacuum configured to apply a vacuum to the porous substrate to vacuum secure the porous substrate to the vacuum and fabricate the GO material membrane from the non-crosslinked GO material coating and the porous substrate.

In any of the disclosed embodiments, the system can further comprise a moving carrier, wherein the porous substrate is configured to move in a substrate direction at a substrate speed, and wherein the moving carrier is configured to carry the vacuum such that the vacuum secured porous substrate moves in the substrate direction at the substrate speed.

Another exemplary embodiment of the present invention comprises a system for fabricating suspensions of GO or rGO into membranes comprising a porous substrate, a slot-die coater configured to apply a GO or rGO suspension across a coating gap and at a GO or rGO suspension flow rate on a top surface of the substrate, the GO or rGO suspension having a GO or rGO suspension concentration, and a vacuum assembly upon which a bottom surface of the porous substrate is supported, the vacuum assembly configured to apply a vacuum to the porous substrate to vacuum secure the porous substrate to the vacuum assembly and fabricate a GO or rGO membrane from the GO or rGO suspension and the porous substrate.

In any of the disclosed embodiments, the system can further comprise a suspension container configured to contain the GO or rGO suspension, and a suspension transport assembly configured to supply the GO or rGO suspension from the suspension container to the slot-die coater.

In any of the disclosed embodiments, the suspension container is configured to contain the GO or rGO suspension and the one or more additives, and the suspension transport assembly is configured to supply the GO or rGO suspension and the one or more additives from the suspension container to the slot-die coater.

In any of the disclosed embodiments, the suspension transport assembly comprises a suspension pump.

In any of the disclosed embodiments, the system can further comprise an additive container configured to contain one or more additives, and an additive transport assembly configured to supply the one or more additives from the additive container to the slot-die coated GO or rGO suspension.

In any of the disclosed embodiments, the slot-die coater is a slot-die coater having two tandem slot-dies, the GO or rGO suspension is applied from one of two tandem slot-dies, and the one or more additives is applied from the other one of the two tandem slot-dies.

In any of the disclosed embodiments, the slot-die coater is a dual layer slot-die coater, the GO or rGO suspension is applied from one of layers of the dual layer slot-die coater, and the one or more additives is applied from the other one of the layers of the dual layer slot-die coater.

Another exemplary embodiment of the present invention comprises a R2R system for GO or rGO membrane fabrication comprising a porous substrate, a slot-die coater configured to apply a GO or rGO suspension across a coating gap and at a GO suspension flow rate on a top surface of the substrate, the GO or rGO suspension having a GO or rGO suspension concentration, and a vacuum assembly upon which a bottom surface of the porous substrate is supported, the vacuum assembly configured to apply a vacuum to the porous substrate to vacuum secure the porous substrate to the vacuum assembly and fabricate a GO or rGO membrane from the GO or rGO suspension and the porous substrate, wherein relative motion between the slot-die coater, the porous substrate, and the vacuum assembly provide for the continuous fabrication of the GO or rGO membrane.

Another exemplary embodiment of the present invention comprises a method of making a membrane, the method comprising forming a first suspension comprising water and a CBN, for example, GO, rGO, and/or hGO, mixing a base into the first suspension to form a second suspension, slot-die coating the second suspension onto a membrane support, vacuum filtering the second suspension onto the membrane support to form a membrane, and conditioning the membrane.

In any of the disclosed embodiments, the CBN can have a concentration in the first suspension from 1 g/L to 50 g/L.

In any of the disclosed embodiments, the CBN can have a concentration in the second suspension from 1 g/L to 50 g/L.

In any of the embodiments disclosed herein, forming the suspension can comprise forming a CBN paste, centrifuging the CBN paste to form a first bottom solids component, washing the first bottom solids component, centrifuging the first bottom solids component to form a second bottom solids component, washing the second bottom solids component to form a CBN material, and suspending the CBN material in water to form the suspension.

In any of the disclosed embodiments, the membrane support can comprise porous poly(ethersulfone) (PES) sheets.

In any of the disclosed embodiments, the method can further comprise dispersing, prior to vacuum filtering, one or more additives, for example, an intercalating agent in the CBN, wherein molecules of the intercalating agent interact with one another and with the CBN through one or more of T-rT or electrostatic interactions.

In any of the disclosed embodiments, the additive can comprise performance enhancing additives such as polyconjugated aromatic molecules.

In any of the disclosed embodiments, the dispersing, prior to the vacuum filtering, the one or more additives, can comprise slot-die coating the additives after the slot-die coating of the CBN suspension on the porous substrate.

In any of the disclosed embodiments, the dispersing, prior to the vacuum filtering, the one or more additives, can comprise mixing the one or more additives in the CBN suspension, and in a single coating step, coating the CBN and additive suspension on the porous substrate.

In any of the disclosed embodiments, the additive can comprise polycyclic dye toluidine blue O (TBO).

In any of the disclosed embodiments, the additive can have a mass ratio compared to CBN of from 11 to 120.

In any of the disclosed embodiments, the formed NF membranes can undergo an aqueous flux change of 5% or less when a pressure is applied from 1 hour to 48 hours.

In any of the disclosed embodiments, the formed NF membranes, when fed with a BL solution comprising 15% weight solids in water, can have a lignin rejection of 98% or greater when under from about 10 bar to about 50 bar of transmembrane pressure.

In any of the disclosed embodiments, the formed NF membranes, when fed with a BL solution comprising 15% weight solids in water, can have a total organic carbon rejection of 80% or greater when under from about 10 bar to about 50 bar of transmembrane pressure.

In any of the disclosed embodiments, the formed NF membranes, when fed with a BL solution comprising 15% weight solids in water, can have a total solids rejection of 50% or greater when under from about 10 bar to about 50 bar of transmembrane pressure.

Another exemplary embodiment of the present invention comprises a method of making a multi-layered membrane by multiple passes of slot-die coating, wherein each layer is a GO layer comprising a plurality of GO flakes, each GO flake comprising a planar graphene structure with oxygen moieties extending therefrom, and wherein an additive is disposed between the two or more GO layers. The additive can be an intercalating agent that interacts with each GO layer, wherein the intercalating agent provides a non-covalent stabilization of the two or more GO layers.

Further features of the disclosed design, and the advantages offered thereby, are explained in greater detail hereinafter with reference to specific examples illustrated in the accompanying drawings, wherein like elements are indicated be like reference designators.

### BRIEF DESCRIPTION OF THE DRAWINGS

Reference will now be made to the accompanying drawings, which are not necessarily drawn to scale, are incorporated into, and constitute a portion of, this disclosure, illustrate various implementations and aspects of the disclosed technology and, together with the description, serve to explain the principles of the disclosed technology. In the drawings:

FIG. 1 is a schematic of an experimental slot-die coating on a roll-to-roll (R2R) with integrated vacuum filtration to form rGO membranes, in accordance with an exemplary embodiment of the present disclosure.

FIG. 2 is a photograph of crossflow membrane permeation test bed showing: (a) the permeation module, (b) BL feed storage drum, and (c) pumping system and controller, in accordance with an exemplary embodiment of the present disclosure.

FIGS. 3A-3I: Photographs of 30×30 cm R2R-rGO membrane coatings showing the influence of suspension concentration: (FIG. 3A) 0.25 g/L; (FIG. 3B) 0.5 g/L; (FIG. 3C) 1.0 g/L; and (FIG. 3D) 2.0 g/L. Photographs of 30×30 cm R2R-rGO membrane coatings showing the influence of substrate speed and flow rate: (FIG. 3E) substrate speed: 4.2 mm/s−flow rate: 2.0 mL/min; (FIG. 3F) substrate speed: 3.0 mm/s−flow rate: 1.5 mL/min; and (FIG. 3G) substrate speed: 3.0 mm/s−flow rate: 2 mL/min. (FIG. 3H) Photograph of an 30×30 cm R2R-rGO membrane coating fabricated with the final operating conditions shown in TABLE 2. (FIG. 3I) Photograph of an 90×30 cm R2R-rGO membrane which meets the characteristics of an acceptable rGO coating without any further adjustment of final coating conditions.

FIGS. 4A-4H: SEM images of PES support and R2R-rGO membrane cross-sections and top surfaces before and after compaction process at 50 bar TMP. PES support cross-sections at different magnifications, (FIGS. 4A-4B) before and (FIGS. 4E-4F) after hydraulic compaction; R2R-rGO membrane supported on PES top surface (FIG. 4C) before and (FIG. 4G) after compaction; tilted cross-section images of R2R-rGO membrane supported on PES, (FIG. 4D) before and (FIG. 4H) after compaction.

FIGS. 5A-5B: Cross-sectional images of R2R-GO membrane at 40K magnification: (FIG. 5A) before and (FIG. 5B) after hydraulic compaction. The double-headed arrows show locations where the thickness of the coated rGO layer was measured by ImageJ and used for statistical averaging.

FIG. 6 is a graph showing an example of reflectance amplitude (Ψ) and phase shift (Δ) ellipsometric spectra from one specific location on an R2R-rGO membrane (solid red and green lines respectively); and the best-fit model prediction (black dotted lines).

FIGS. 7A-7B: Examples of ellipsometric thickness maps from the R2R-rGO membrane showing the existence of continuous coatings as well as thickness variation features such as “hills and valleys” and localized “spots” with lower coating thickness.

FIGS. 8A-8D: Stability of the R2R-rGO membrane: (FIG. 8A) 2×2 cm sections of R2R-rGO membrane before and after submersion in deionized (DI) water and BL for 21 days at ambient temperature; (FIG. 8B) photograph of the R2R-rGO membrane before and after the peel test (ASTM D3359); (FIG. 8C) photograph of an R2R-rGO membrane after 50 h of water compaction at 50 bar and 25° C.; and (FIG. 8D) photograph of an R2R-rGO membrane after permeation measurements of 310 h duration in BL at 50 bar and 72° C.

FIGS. 9A-9B: XPS C1s spectrum of (FIG. 9A) an R2R-rGO membrane (red trace) and fitted peaks corresponding to different carbon environments (blue, purple, green); and (FIG. 9B) the corresponding original GO material before chemical reduction.

FIGS. 10A-10B: (FIG. 10A) Permeate flux behavior during long-term pressure cycling operation of a R2R-rGO membrane. A real BL feed is used at 72° C. and 5.6 L/min flow rate. Five TMP values are used: 10 bar (black), 20 bar (yellow), 30 bar (blue), 40 bar (pink), and 50 bar (green). (FIG. 10B) Steady-state flux and lignin rejection values versus TMP.

FIGS. 11A-11C: (FIG. 11A) Permeate fluxes during 5 wash-operate cycles. Data from two R2R-rGO membranes are shown (solid and open symbols). Durations and pressures of water wash (blue lines and labels) and BL operation (red lines and labels) are denoted. (FIG. 11B) Lignin rejections versus time for both membranes over 5 wash-operate cycles. (FIG. 11C) Steady-state (triangles) and average (squares) permeate production fluxes during each BL operation duration in each cycle. The mean value (difference) from the two membranes is shown as the data symbol (error bar).

FIG. 12: Permeate flux and lignin rejection of an R2R-rGO membrane operating with a 26.2 wt % BL feed at 50 bar and 72° C.

### DETAIL DESCRIPTION OF THE INVENTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some examples,” “example embodiment,” “various examples,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising,” “containing,” or “including” it is meant that at least the named element, or method step is present in article or method, but does not exclude the presence of other elements or method steps, even if the other such elements or method steps have the same function as what is named.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain examples and implementations of the disclosed technology are described above with reference to block and flow diagrams of systems and methods and/or computer program products according to example examples or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some examples or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, examples or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Embodiments of the disclosed technology include the scaled fabrication and characterization of a membrane system configured to remove lignin from black liquor, formed by slot-die coating on a R2R with integrated vacuum filtration.

In some embodiments, the membrane system may include a nanofiltration (NF) membrane. The NF membrane can, in some embodiments, comprise a macroporous polymer substrate and a GO membrane. Because BL is typically discharged having a temperature in the range of about 70° C. to about 95° C., in some embodiments, the macroporous polymer substrate may be at least partially composed of a polymer having a thermal stability limit greater than the typical temperature of the black liquor. For example, certain embodiments may include a polymer having a thermal stability limit greater than about 70° C., some embodiments may include a polymer having a thermal stability limit greater than about 80° C., and some embodiments may include a polymer having a thermal stability limit greater than about 95° C. In certain embodiments, the polymer may have a thermal stability limit in the range of about 70° C. to about 150° C. In some embodiments, the polymer may have a thermal stability limit in the range of about 70° C. to about 95° C. It should be understood that this disclosure is not limited to only those polymers having thermal stability limits expressly recited herein and that any polymer having a thermal stability limit sufficient to withstand the thermal environment provided by the discharged BL is herein contemplated. In certain embodiments, the membrane system can have a flux of BL in the range of about 10 kg/m²/h to about 30 kg/m²/h. And in some embodiments, the membrane system can be resistant to high pH as well as resistance to fouling at transmembrane pressures of about 10 bar to about 35 bar.

In some embodiments, the macroporous polymer substrate may comprise one or more polymers with aryl groups. For example, some embodiments may include poly(sulfone) (PSF) or poly(ethersulfone) (PES). Certain embodiments may include a polymer with a relatively high hydrophilicity, which may result in higher water flux and may provide strong adhesion to the GO membrane.

According to some embodiments, partially oxidized graphene layers can be stacked to form a GO membrane. In some embodiments, the spacing between the GO layers (d-spacing) can be altered to control the effective pore size of the GO membrane, i.e., the median or mean size of the pores of the GO membrane, which dictates, based on the size of matter or objects, which matter or objects are permitted to pass through the GO membrane and which are retained or rejected by the GO membrane. In some embodiments, the GO membrane at least partially covers the macroporous polymer substrate. In some embodiments, the GO layers are comprised of GO flakes. The GO flakes can have a thickness of about 3 nm to about 10 nm. In some embodiments, the GO flakes can have a thickness of about 5 nm to about 6 nm. In some embodiments, the GO flakes have a lateral dimension of about 200 nm to about 1000 nm. In some embodiments, the GO flakes have a lateral dimension of about 200 nm to about 500 nm.

In some embodiments, the thickness of the GO membrane may be less than or equal to about 300 nm. In certain embodiments, the d-spacing of the GO membrane can be dimensioned such that the NF membrane is configured to remove or reject lignin from black liquor. For example, in some embodiments, the NF membrane may have a molecular weight cutoff from about 300 Daltons to about 500 Daltons. In some embodiments, the NF membrane may have a molecular weight cutoff from about 500 Daltons to about 1000 Daltons. (Molecular weight cutoff refers to lowest molecular weight of a solute in which 90% of the solute is retained by a membrane.) In certain embodiments, the GO membrane of the NF membrane may comprise pores in the range of about 3 angstroms to about 15 angstroms. In some embodiments, the GO membrane may comprise pores in the range of about 7 angstroms to about 10 angstroms. In some embodiments, the GO membrane may comprise pores in the range of about 3 angstroms to about 10 angstroms. Some embodiments may reject lignin at a rate greater than or equal to about 90%. For example, some embodiments may reject lignin at a rate of about 95% to about 99%.

Some embodiments of the disclosed technology may be manufactured by treating raw graphite with an acid treatment to produce a GO powder. In certain embodiments, the GO powder may then be treated with base reflux. In other embodiments, the GO powder is not treated with base reflux. In some embodiments, the GO powder is dispersed into water. According to some embodiments, exfoliated GO laminates of the GO powder may be separated from unexfoliated GO laminates of the GO powder, and in some embodiments, the exfoliated GO laminates may be deposited on a polymer substrate. In some embodiments, the polymer substrate is a macroporous polymer substrate. In certain embodiments, the exfoliated GO laminates are then dried to provide a GO membrane. Drying the exfoliated GO laminates can include active drying (e.g., placing the polymer substrate into an oven) or passive drying (e.g., waiting for the water to evaporate). In some embodiments, the GO membrane may be modified. For example, in some embodiments, the GO membrane may be modified with organic reagents, such as amines, aldehydes, dialdehydes, thiols or other reagents capable of forming chemical or physical bonds with the GO membrane. This may, for example, provide crosslinking of the GO layers and may lead to covalent bonding between sheets, which may reduce d-spacing, and the d-spacing may be adjustable by using different reagents.

There are many processes for coating the CBN/GO/rGO suspension on the porous substrate. For example, coating technologies include slot-die, curtain, and knife coating are able to manufacture thin films. These techniques were designed for creating high quality films in continuous single sheets. These techniques, however, have a limited ability to create patterns.

Slot-die coating is a method of creating thin films on a substrate from liquid materials. The essence of the process is a die consisting of two halves separated by a shim, with a pressurized reservoir, or chamber, machined into one of the halves containing fluid. The purpose of the shim is to create a gap between the two halves through which the fluid may flow. The purpose of the chamber is to uniformly distribute the fluid therein along the width of the gap. As a result, slot-die designs are generally limited to lines or stripes that are the opening of the shim, thereby limiting the ability of the slot-die to create other desired patterns.

According to some embodiments, the coating tool (e.g. slot-die, hybrid patterning apparatus) has an array of two or more suspension inlets, a flow of suspension into the hybrid coating apparatus, and a region of outflow of the suspension out of hybrid coating apparatus and onto the porous substrate. The hybrid patterning apparatus can further include a substrate, a suspension outflow from hybrid patterning apparatus, wherein a liquid bridge between a coating tool outlet region and the deposited suspension, and a die plate of the hybrid patterning apparatus.

During operation, one or more liquid bridges form between the coating tool outlet and the substrate. The transfer of suspension through each liquid bridge, in turn, forms a patterned liquid film on the substrate surface.

The hybrid slot coating tool can include a slot-die that includes a die body having two halves, or first and second plates, separated by one or more shims with cutout(s) forming a slot-shaped cavity positioned between first and second plates for containing suspension to be deposited. It further includes an array of inlets for delivering suspension to discrete regions of the internal geometry, an external manifold or distribution chamber for suspension delivered to an inlet array.

In another embodiment, the first and second plates can be separated by one or more shims with cutout(s) forming an internal slot-shaped cavity, internal distribution chambers, channels or cavities with inlet ends integrated into one or more of the plates. In some exemplary embodiments, the internal distribution chambers, channels or cavities are converging. The purpose of shim(s) is to create a slot gap between first and second plates through which the suspension may flow. In some exemplary embodiments, slot gap can lead from cavity to an opening or a series of channel outlet ends. In some exemplary embodiments, cutouts in the shims define the geometry of the slot, and the shims can be interchanged to implement different flow behaviors and patterning strategies. At least two suspension inlets can be used to feed suspension to the slot. However, in some exemplary embodiments, multiple separate suspension inlets can be used (e.g., 3 inlets, 4 inlets, 5 inlets, 6 inlets, 7 inlets, 8 inlets, 9 inlets, 11 inlets, 13 inlets, 15 inlets, 17 inlets, 20 inlets).

The shim configuration can be used for simultaneous deposition of two or more coating materials as alternating stripes. A heterogeneous multi-material stripe pattern is produced when two materials are fed into alternating inlets (for example, corresponding both to alternating height positions of two rows of inlets, and alternating width positions of each inlet of the two rows of inlets, alternating laterally along a width of the slot-die) of the hybrid slot coating tool. While slot coating has previously been adapted for deposition of narrow stripes of a single material, the present invention can deposit two or more coatings simultaneously into a single-layer pattern.

The array of inlets can include a first set of fluid inlets that lie in a row at a first height of the slot-die across the width of the slot-die, and a second set of fluid inlets that lie in a row at a second height of the slot-die across the width of the slot-die, wherein the first height is different than the second height, such that the length of each of the inlet channels of the first set is different than the length of each of the inlet channels of the second set.

The slot-die body can be made of any machinable material typically used in making slot-die. These include but are not limited to stainless steel, aluminum, titanium, nylon, polycarbonate and combinations thereof. The material used to make slot-die body generally is a function of the fluid that will be deposited. There should be compatibility between the slot-die and the fluid with respect to chemical, electrical, mechanical, and physical properties.

In some exemplary embodiments, a pattern-scaling mechanism can cause interaction between different materials without a shim, which is not disruptive to the pattern formation.

In another exemplary embodiment, the apparatus for patterning thin films can comprise the slot-die, a first set of suspension inlets for feeding the first suspension material into the slot-die, a second set of suspension inlets for feeding the second suspension material into the slot-die, a first set of inlet channels laterally spaced apart and configured to receive the first suspension material, each of the inlet channels of the first set of inlet channels having a channel inlet coincident with a respective suspension inlet of the first set of suspension inlets in the slot-die, a second set of inlet channels laterally spaced apart and configured to receive the second suspension material, each of the inlet channels of the second set of inlet channels having a channel inlet coincident with a respective suspension inlet of the second set of suspension inlets in the slot-die, and a third interaction channel communicative connected at an upstream end to the first and second sets of inlet channels, and at a downstream end to the suspension multi-material outlet in the slot-die through which a pattern of alternating first suspension material and second suspension material can flow, wherein the first set of inlet channels and the second set of inlet channels are arranged in an alternating order, such that an inlet channel of the first set of inlet channels is followed by an inlet channel of the second set of inlet channels as viewed laterally across the slot-die, wherein the third interaction channel is configured to receive at the upstream end alternating flows of the first suspension material and the second suspension material from the alternating layout of inlet channels, wherein the third interaction channel defines a volume extending in a flow direction from the upstream end to the downstream end and is further configured such that the third interaction channel is free of a physical barrier separating the flows of the first suspension material and the second suspension material, and wherein the volume of the third interaction channel has a converging cross-sectional area from a width of the upstream end to a width of the downstream end, which is smaller than the width of the upstream end.

These relationships between coating bead behavior and feature size control can be understood in the context of a balance of viscous, interfacial, and inertial forces at the dynamic liquid bridge beneath the tool. Viscous shear appears to limit lateral spreading of the coating bead along the coating outlet. Surface tension at the liquid-gas interface limits spreading counter to interfacial forces associated with the solid-liquid interfaces. The balance between liquid-gas and solid-liquid interfacial force is also a function of the shape of the liquid bridge.

The substrate can be moved at any suitable velocity to enable coating of the substrate. For example, according to exemplary embodiments of the present invention, a velocity of 25-100 feet per second is particularly preferred.

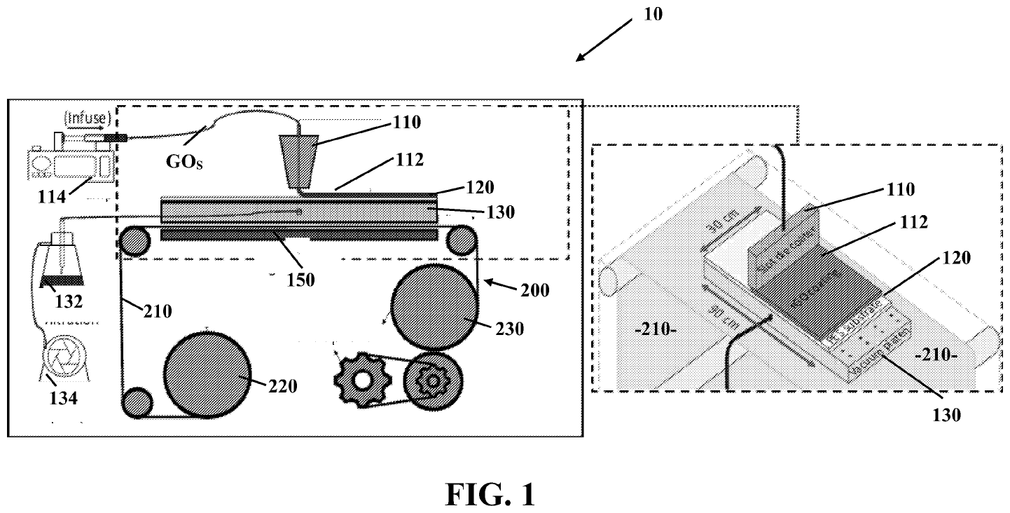

As shown in FIG. 1, an exemplary system 10 comprises a slot-die coater 110, porous substrate 120, a vacuum assembly 130, and a moving carrier 210.

The slot-die coater 110 is configured to apply a GO suspension GOs in the form of a GO coating 112 across a coating gap and at a GO suspension flow rate on a top surface of the porous substrate 120, the GO suspension having a GO suspension concentration.

The porous substrate 120 is configured to move in a substrate direction at a substrate speed.

The vacuum assembly 130, upon which a bottom surface of the substrate 120 is supported, is configured to apply a vacuum to the substrate 120 to vacuum secure the substrate 120 to the vacuum assembly 130 and fabricate a GO membrane from the GO coating 112 and the substrate 120.

The moving carrier 210 is a component of a carrier system 200. The vacuum assembly 130 is carried on the carrier 210 such that the vacuum secured substrate 120 moves in the substrate direction at the substrate speed.

In an exemplary embodiment, the substrate 120 is a porous poly(ethersulfone) (PES) substrate sheets with 130 μm thickness, 0.03 μm pore size, and 79% porosity, and used as supports for fabricating reduced graphene oxide (rGO) membranes. The rGO NF membranes on PES substrate sheets were fabricated by a dynamic customized process—using slot-die coating on a R2R with integrated vacuum filtration.

The PES substrate sheets with the size of three feet by one foot (˜90×30 cm) were placed on the vacuum assembly 130 (a vacuum platen) using a vacuum filtration method. The edges of the substrate sheets were taped down on the platen to secure a sealed vacuum process. Then, the vacuum platen was placed on the carrier 210 (a polyethylene terephthalate (PET) carrier base of the carrier system 200 (an R2R system), which drags the vacuum platen at a specified velocity. The rGO suspension (4 g/L in water) was sonicated three times for 20 min each in 1 min intervals (i.e., total 60 min) to exfoliate the rGO laminates.

The prepared rGO suspension was poured into a syringe pump 114 that is installed on the R2R system and connected to the slot-die coater 110 with a tube. The coating gap between the surface of the substrate sheet and the base of the slot-die was set as 100 μm. The thickness of the shim inside the slot-die (slot gap) was 620 μm.

The substrate sheet velocity was controlled at different values in the range of 3-5 mm/s by a motor. After the complete distribution of rGO solution on the surface of the substrate sheet, and complete pass of the vacuum platen under the slot-die, the substrate sheet was air-dried.

GO and rGO synthesis used fine grade synthetic graphite laminate powder (particle size <20 μm), sulfuric acid (H₂SO₄), hydrochloric acid (HCl), potassium persulfate (K₂S₂O₈), potassium permanganate (KMnO₄), phosphorus pentoxide (P₂O₅), hydrogen peroxide solution (H₂O₂ 30% w/w) and 0.2 μm Whatman filter paper were purchased from Sigma-Aldrich (St. Louis MO, USA).

Stock softwood BL (TS 15.7 wt % with pH ˜12.7) was obtained from a pulp and paper mill (International Paper, Port Wentworth GA, USA). TABLE 1 is a summary of properties and chemical composition of this softwood kraft BL.

TABLE 1

| | |
|---|---|
| Total Solids (wt %) | 15.7 |
| Density (g/cm3) | 1.09 |
| Water (% by mass) | 84.3 |
| Total Carbon (g/L) | 57.54 |
| Total Inorganic Carbon (g/L) | 2.76 |
| Total Organic Carbon (g/L) | 54.78 |
| Na (g/L) | 32.08 |
| S (g/L) | 7.64 |
| K (g/L) | 2.45 |
| Ca (g/L) | 0.025 |
| Mg (g/L) | 0.014 |
| Fe (g/L) | 0.01 |
| Si (g/L) | 0.05 |
| S₂O₃²⁻ (g/L) | 3.48 |
| SO₄²⁻ (g/L) | 9.22 |
| SO₃²⁻ (g/L) | 0.205 |
| Cl⁻ (g/L) | 0.321 |
| pH (20° C.) | 12.7 |

PES substrate sheets were purchased from Sterlitech (Auburn WA, USA). All these materials were used as received. Deionized (DI) water was produced with a Thermo Scientific 7128 deionization system.

GO and rGO were synthesized following our previous works using a modified Hummers method [16, 17]. This process starts with a graphite pretreatment step, in which 12 mL of 98% H2SO4 was slowly added to a beaker containing 3 g of graphite powder while stirring.

Then, 2.5 g of P₂O₅ and 2.5 g of K₂S₂O₈ were slowly added to the beaker and the whole mixture was stirred for 4 hrs after reaching the temperature of 800° C. After cooling to room temperature and then adding 500 mL of DI water, the resulting mixture was vacuum-filtered with 0.2 μm filter paper over night to remove any additional acids and oxidizing agents.

In the graphite oxidation step, the pretreated graphite powder was removed from the filter paper and added to 120 mL of H₂SO₄ at a temperature of 0° C.

Then, 15 g of KMnO₄ was slowly added to the mixture while the temperature was kept below 20° C. by an ice bath. Then, the ice bath was removed, and the temperature was raised to 35° C. over 30 min.

Very slowly, 250 mL of DI water was added to the mixture while keeping the temperature between 40° C. and 50° C. After stirring for 2 hrs, 700 mL of DI water was added to the mixture.

Then, 20 mL of H₂O₂ was slowly added to the mixture until its color turned yellowish/greenish, indicating MnO₄⁻ reduction to water-soluble Mn²⁺.

Then, the graphite oxide was centrifuged at 4000 rpm for 15 min. At the end of the centrifuging step, the supernatant solution was discarded.

The suspension at the bottom of the centrifuge tubes was collected and washed with ˜500 mL of DI water and centrifuged at 4000 rpm for 15 min.

After repeating the previous step for two times, the suspension was washed with ˜500 mL of 1 molar HCl and centrifuged at 4000 rpm for 15 min. Then, the suspension was washed several times with ˜500 mL of DI water until it reached neutral pH ˜7.

The suspension was then ultrasonicated for 2 hrs in a sonication bath, to produce an exfoliated GO suspension. The GO suspension was then centrifuged at 4000 rpm for 15 min, and the supernatant (reddish/brownish color) was collected.

The cycle of ultrasonication-centrifugation was repeated 3-4 times, after diluting the concentrated suspensions at the bottom of the centrifuge tubes each time with DI water (40-50 mL per tube).

The result was an aqueous GO suspension with typically about 7 g/L GO concentration, as calculated by measuring the wet and dry weights of a known volume of the GO suspension.

After this step, the GO suspension was converted to an rGO suspension by adding about 0.25 g NaOH to 100 mL of the GO solution and stirring for at least 30 min.

Then, the mixture was heated to reflux at 100° C. by a flux condenser for 2 hrs.

As a final step and to have a stable rGO suspension, the mixture was ultrasonicated for 30 min. The concentration of GO/rGO was calculated based on the wet and dry weights of a certain volume of GO/rGO suspension.

### Characterization of the Fabricated rGO Membranes

The surface and cross-sectional morphologies of the fabricated rGO membranes were analyzed by scanning electron microscopy (SEM, Hitachi SU8010 operate at 10 keV, 10 μA). SEM samples were about 0.5 cm in size and were chosen from different locations of the membranes. SEM was used to study the cross-section of the membranes to measure the thickness of the coated rGO layer, and to study the surface of the membranes to examine the uniformity of the coated rGO layer.

In addition to SEM, ellipsometry (Woollam M2000) was used to comprehensively characterize membrane thickness over large areas of the R2R-processed membrane surface. Ellipsometry was performed on 48 samples with the size of 4×1 cm (area of 4 cm²) chosen from different parts of the rGO membrane.

The membrane was divided in twelve zones with the size of about 15×15 cm, and each zone was divided in four sections of about 7×7 cm. In each of these sections, a randomly chosen area of 4×1 cm was characterized by ellipsometry to study thickness and roughness.

In this manner, an area comprising a total of 192 cm² (48×4 cm²) systematically selected from different locations of the entire R2R-rGO membrane sheet (2700 cm²) was characterized by ellipsometry for different properties such as thickness and roughness.

The surface chemistry of the fabricated membranes was studied by X-Ray Photoelectron Spectroscopy (XPS, Thermo Kα). The rGO samples for XPS were prepared by placing three droplets of rGO solution on a small silicon wafer piece and air-drying for 48 hrs. The rGO membrane samples for XPS were prepared by cutting small pieces of R2R-rGO membrane in appropriate size. The adhesion of the rGO coated layer on PES substrate was tested by peel test (ASTM D3359 standard).

To prepare these samples, a 4×4 cm piece of membrane was cut from nine different parts of the membrane including the left, center, and right sides of the top, middle, and bottom parts. The stability of the rGO coated layer on the PES substrate was examined by submerging six 2×2 cm pieces of the cut membranes in DI water and BL and monitoring over the period of three weeks.

### Permeation Measurements

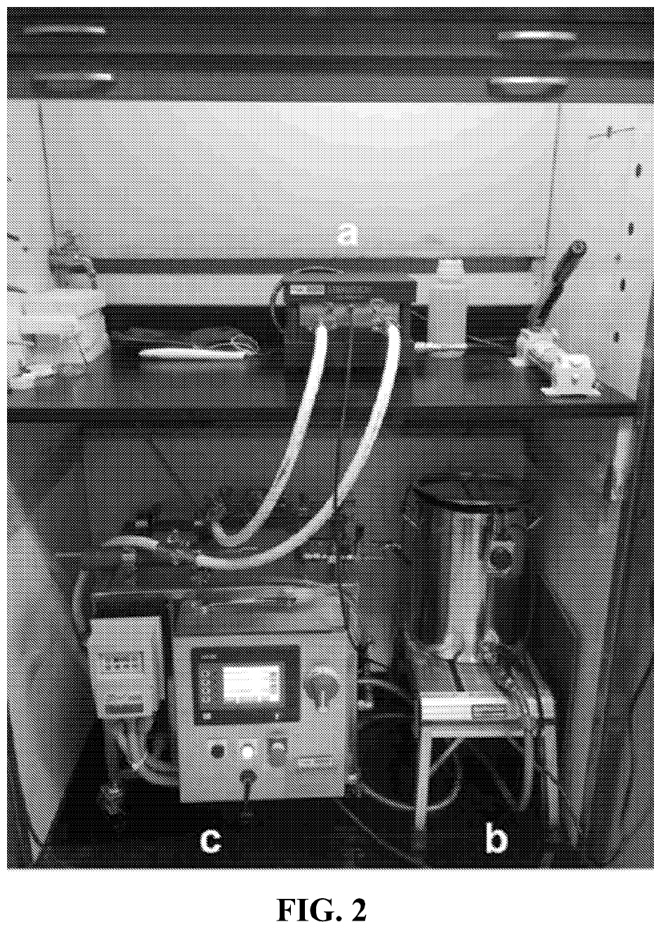

Permeation measurements on R2R-rGO membranes were carried out in a crossflow permeation test bed shown in FIG. 2. Transmembrane pressures (TMPs) of 10, 20, 30, 40, and 50 bar were used for each set of permeation measurements and were monitored by a pressure gauge.

The R2R-rGO membranes were cut into 19×14 cm rectangular sheets and placed in the crossflow cell, supported by a fine stainless-steel mesh.

For a single run, 20 L of feed (such as DI water or 15.7 wt % TS kraft BL) was filled in the feed storage drum, and the drum was heated with an immersion heater to the desired temperature. DI water permeation measurements were carried out first to verify the integrity of the membrane, and the feed was then switched to BL. Both the retentate and permeate streams continuously flow back into the storage drum to reconstitute the feed.

To determine the membrane flux, the mass flow rate of the permeate stream is occasionally sampled using collection vials. When steady-state flux was reached in each BL permeation measurement, a 20 mL permeate sample was separately collected for composition measurement.

The permeate flux J (L m²h⁻¹) was calculated as J=V/AΔt, where V is the permeate volume collected in a given time span Δt and A is the membrane area. The porosity of the PES substrate was calculated by a gravimetric method. The dimensions (area and thickness) of the substrate, and hence its total bulk volume, are known. The porous volume was obtained by measuring the increase in mass of the substrate after soaking in DI water for 24 h relative to its dry mass and dividing this mass increase by the density of water (taken as 1 g/mL). The porosity is then the ratio of the porous volume and the total bulk volume.

### Determination of Lignin Rejection

The lignin concentration was determined by first diluting the sample (feed or permeate) with a pH=13 buffer solution and measuring its UV-Vis absorbance at 290 nm (Agilent, 8510 UV-Vis Absorption Spectrophotometer), with calibration performed according to Beer's law. The lignin rejections were calculated based on the formula

$$R = ( 1 - {C}_{p} / {C}_{f} ) \times 100 \% ,$$

where C, and C_{f} are the concentrations (g/L) of the component in the permeate and the BL feed, respectively.

### Characterization of Stock BL

The density of BL samples was measured by weighing a certain volume of BL in a crucible. The TS content of the feed and permeate samples were measured by drying approximately 1 g of the solution in a glass vial containing fine white sand at 105° C. for at least 8 hrs and measured the mass difference on a digital balance.

The total carbon (TC) and total inorganic carbon (TIC) concentration in g/L were determined by a coulometer, following the standard procedures for BL (see TABLE 1 and [33] Arthur L. Fricke, Abbas A. Zaman, A Comprehensive Program To Develop Correlations For Physical Properties Of Kraft Black Liquor. Final Report, University of Florida: Gainesville, (1998), https://doi.org/10.2172/656611; [34] CM150 Carbon Analysis (TC/TIC/TOC) By Combustion, Acidification And Coulometric Detection, http://www.uicinc.com/cm150/index.html, and [35] Determination Of Inorganic Carbon In Black Liquors. http://www.uicine.com/determination-of-inorganic-carbon-in-black-liquors/index.html.

The total organic carbon (TOC) concentration was calculated by subtracting the TIC concentration from the TC concentration. Sodium (Na), sulfur (S) and trace metals (potassium (K), calcium (Ca), magnesium (Mg), etc.) were determined by ICP. Sulfate (S₄²⁻), sulfite (S₃²⁻), thiosulfate (S₂O₃²⁻), and chloride (Cl⁻) were determined by capillary ion electrophoresis.

### Results and Discussion

Multiple membrane fabrication experiments were carried out using the R2R system. In these experiments, the role of the main three factors [[36]: Xiaoyu Ding, Tequila A. L. Harris, Review On Penetration And Transport Phenomena In Porous Media During Slot-die coating, (2017), J. Polym. Sci. Part B: Polym. Phys., 55: 1669-1680, https://doi.org/10.1002/polb.24307] influencing the coating characteristics, i.e., rGO suspension concentration, suspension flow rate, and substrate speed, were systematically determined while fabricating membranes with the size of 30×30 cm.

The considered coating gap and slot gap were kept constant to minimize the number of the variables influencing the R2R process. A sample of suspension flow rate and substrate speed were explored in this work, to identify coating conditions that allow for high quality R2R-rGO membrane fabrication with little to no defects in, for example, nonuniformity, delamination, streaks, rivulets, air entrainment, ribbing, barring, or waviness [27] and [[37]: Kanthi Latha Bhamidipati, Sima Didari, Prince Bedell, Tequila A. L. Harris, Wetting Phenomena During Processing Of High-Viscosity Shear-Thinning Fluid, Journal of Non-Newtonian Fluid Mechanics, Volume 166, Issues 12-13, (2011), Pages 723-733, ISSN 0377-0257, https://doi.org/10.1016/j.jnnfm.2011.03.009.]

In this context the rGO suspension concentration plays an important role and must be assessed as part of the R2R process. Static batch mode vacuum filtration can use very dilute (0.01-0.1 g/L) rGO suspensions, since the suspension is confined to a fixed spatial area during the entire coating time, and the final coating thickness can be controlled easily by adjusting the total volume of the suspension used [16, 17].

On the contrary, the dynamic mode of the R2R vacuum filtration process requires much more (100 times) concentrated suspensions, in order to provide the desired coating thickness and uniformity within the much shorter time interval in which the solvent (water here) permeates through the substrate under the pressure differential.

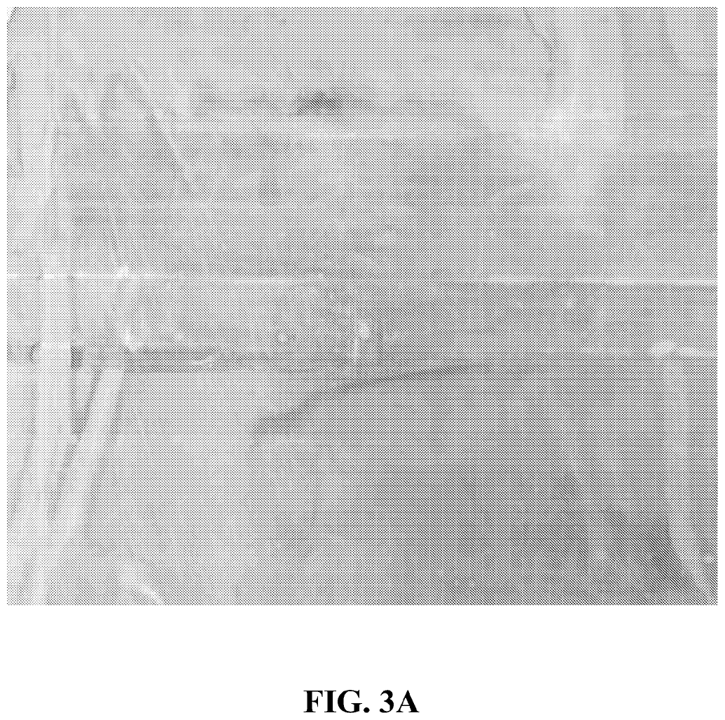

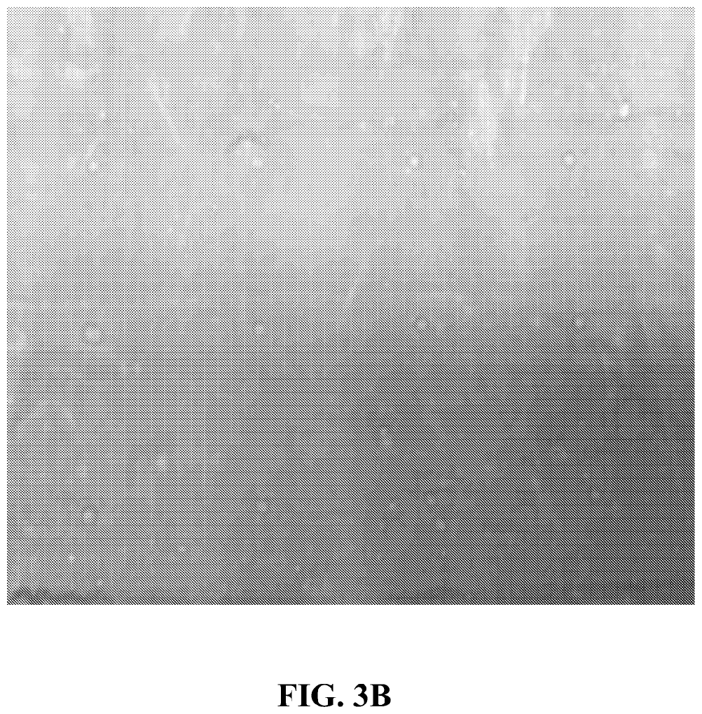

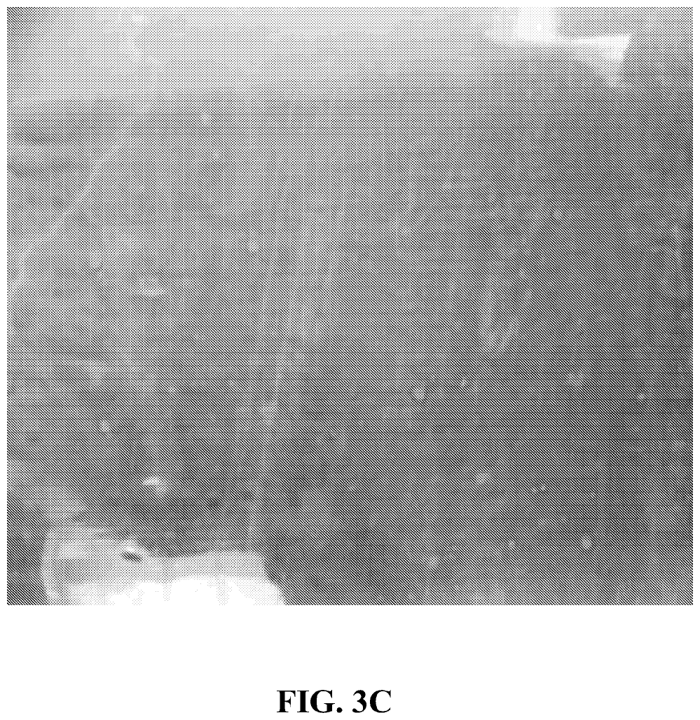

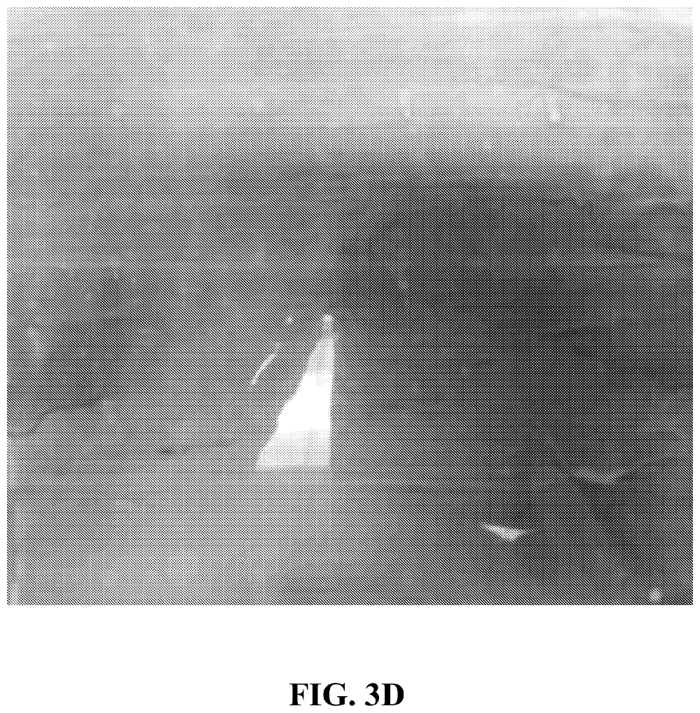

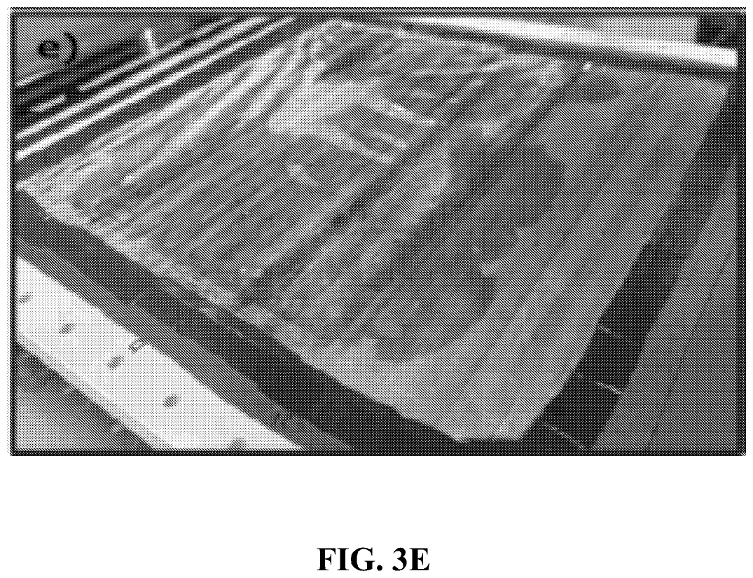

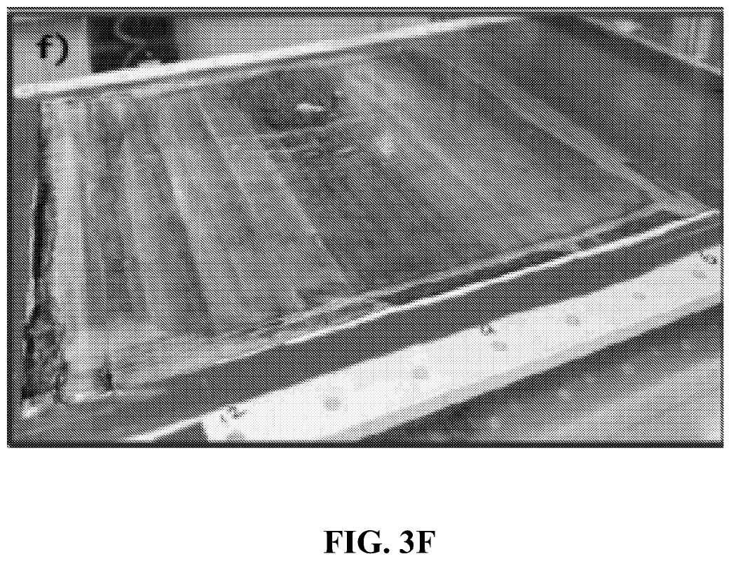

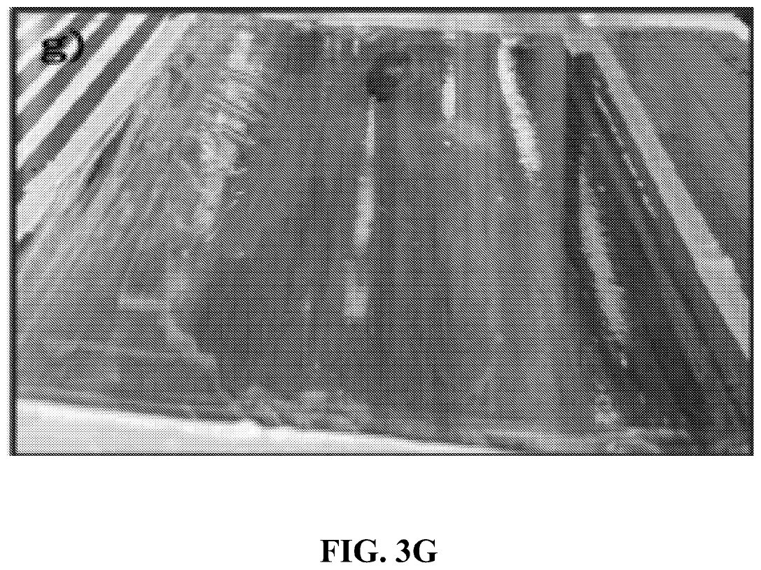

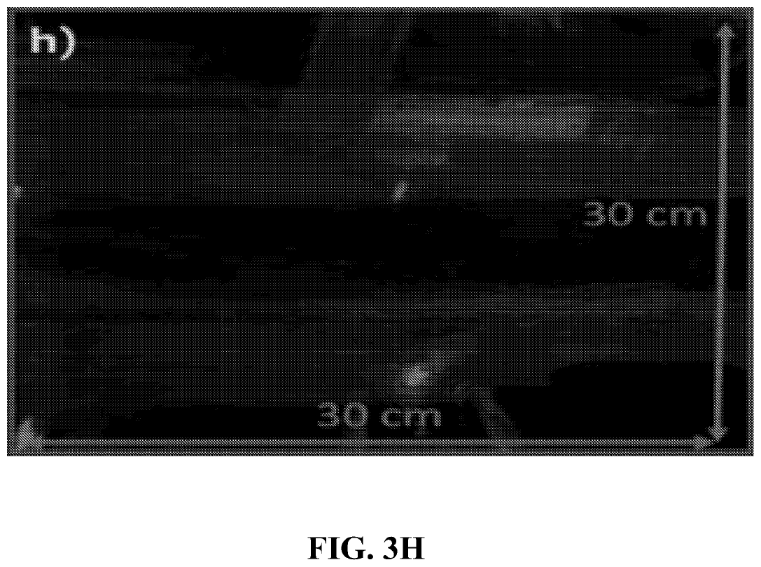

The two main characteristics considered to define an acceptable rGO membrane coating are full coating of the PES substrate (no pinholes, uncoated areas) and the thickness uniformity of the coated rGO layer. In order to study the impact of rGO suspension concentration on the quality of R2R-rGO membranes, six different concentrations (0.25, 0.5, 1.0, 2.0, 3.0, and 4.0 g/L) were studied. The lower rGO concentrations (0.25-1.0 g/L) did not result in a uniform coating, and there were areas with no visual signs of rGO coating (FIGS. 3A-3C).

The suspension concentration of 2.0 g/L resulted in an improved quality in terms of achieving a full rGO coating on the whole PES substrate (FIG. 3D). With this fixed concentration, the impact of suspension flow rate in the range of 1.0-3.0 mL/min and substrate speed in the range of 3.0-5.5 mm/s were then investigated.

It was observed that high suspension flow rate and low substrate speed result in a fully coated PES substrate according to visual observations. However, these fabricated rGO membranes also showed different types of defects such as nonuniformity (FIG. 3E) and streaks (break lines) (FIG. 3F).

According to [[38]: Wen-Bing Chu, Jia-Wei Yang, Yu-Chin Wang, Ta-Jo Liu, Carlos Tiu, Jian Guo, The Effect Of Inorganic Particles On Slot-die coating Of Poly(Vinyl Alcohol) Solutions, Journal of Colloid and Interface Science, Volume 297, Issue 1, (2006), Pages 215-225, ISSN 0021-9797, https://doi.org/10.1016/j.jcis.2005.10.056; [39]: Yu-Rong Chang, Hsien-Ming Chang, Chi-Feng Lin, Ta-Jo Liu, Ping-Yao Wu, Three Minimum Wet Thickness Regions Of Slot—die coating, Journal of Colloid and Interface Science, Volume 308, Issue 1, (2007), Pages 222-230, ISSN 0021-9797, https://doi.org/10.1016/j.jcis,2006.11.054; and [40]: T. D. Blake, Kenneth J Ruschak, A Maximum Speed Of Wetting, Nature 282, 489-491 (1979), https://doi.org/10.1038/282489a0], streaks could be the result of high substrate speeds relative to the flow rate of the fluid. Since the effects of substrate speed and suspension flow rate are highly interconnected, we were able to prevent the streak (break lines) defects by increasing the suspension flow rate at a fixed substrate speed (FIG. 3G).

Furthermore, the coating thickness could then be adjusted by using higher concentrations (e.g., 4.0 g/L) of the rGO suspension (FIG. 3H).

The above approach allowed us to broadly identify an acceptable set of coating conditions with a reasonable number of experiments. However, obtaining a comprehensive set of coating conditions to significantly expand the rate of fabrication for the R2R-rGO membrane (i.e., coating window) was outside the scope of the present paper because of the complex nature of this process. The final operating conditions selected for continuous coating of high-quality rGO membranes used hereinbelow are presented in TABLE 2. Furthermore, we verified the scalability and quality of membranes made with these operating condition by fabricating a longer (90×30 cm) rGO membrane (FIG. 3I) which also meets the characteristics of an acceptable rGO coating without any further adjustment of coating conditions.

TABLE 2

| Suspension | Substrate | Coating | Slot | rGO |
|---|---|---|---|---|
| flow rate | speed | gap | gap | concentration |
| (mL · min⁻¹) | (mm · s⁻¹) | (μm)* | (μm)* | (g · L⁻¹) |
| 2.0 | 3.0 | 100.0 | 620 | 4.0 |

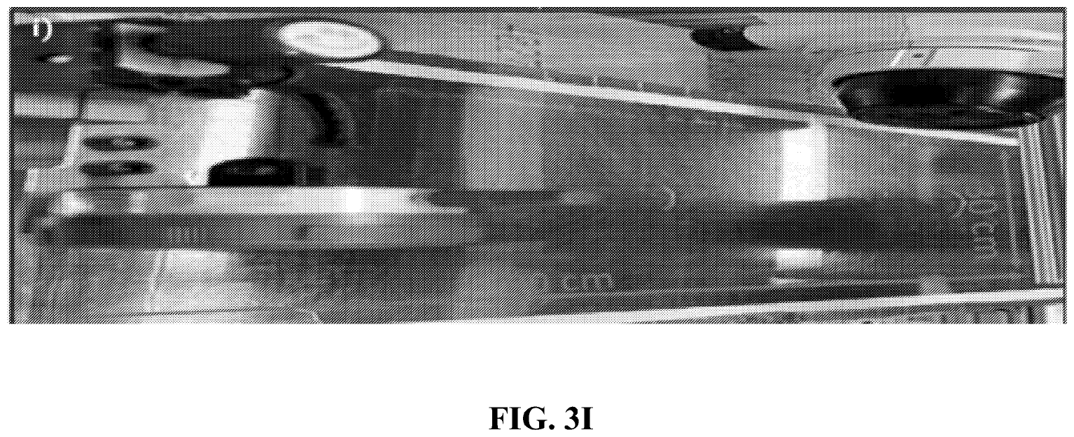

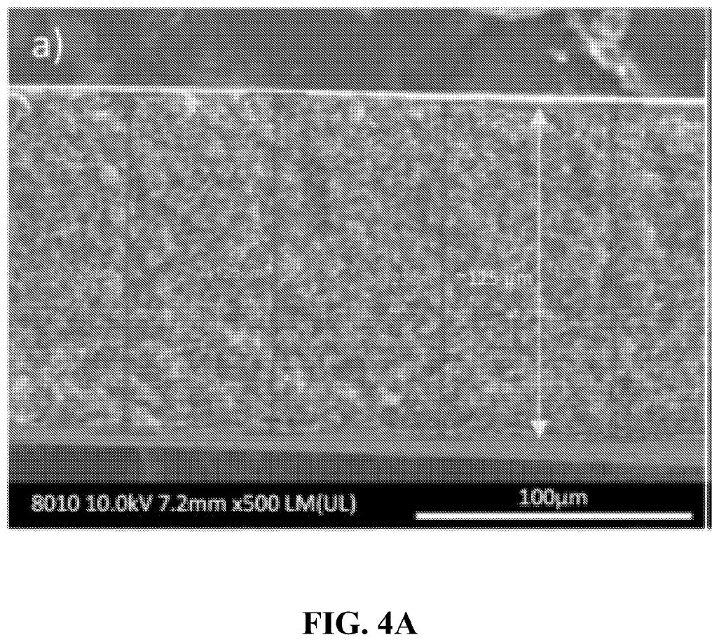

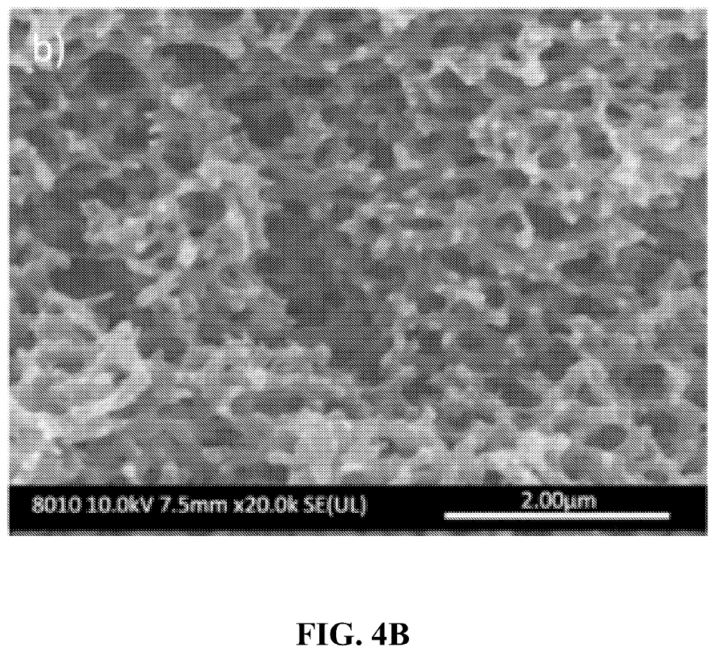

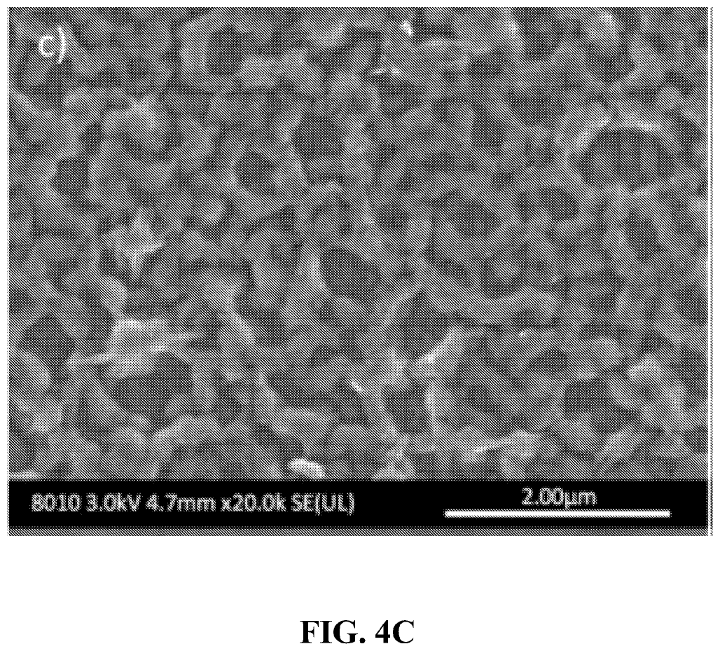

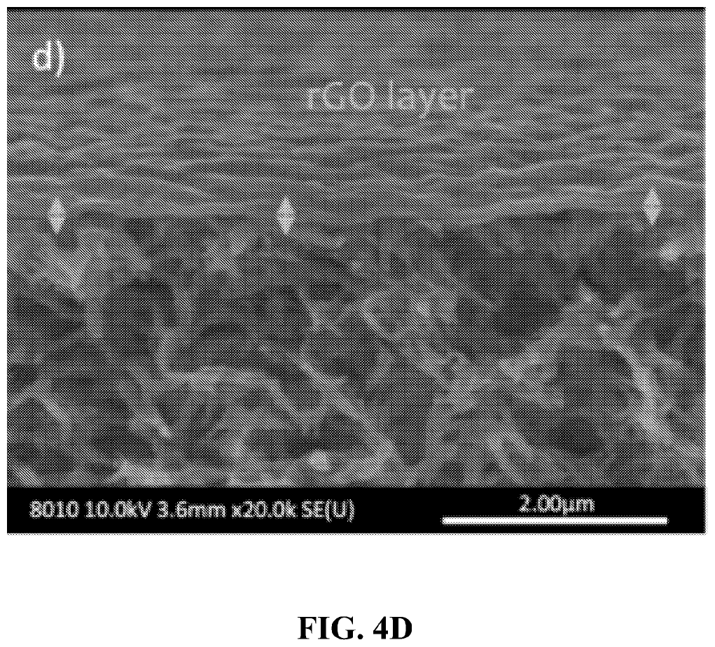

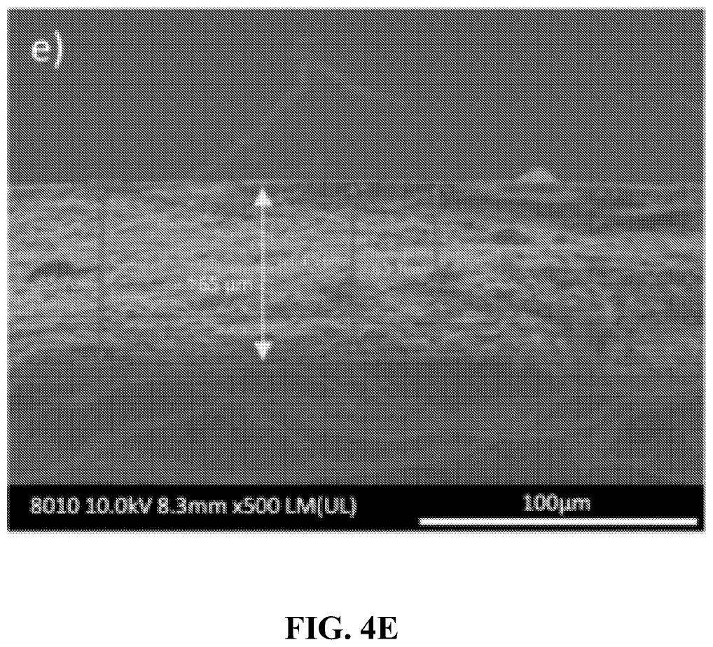

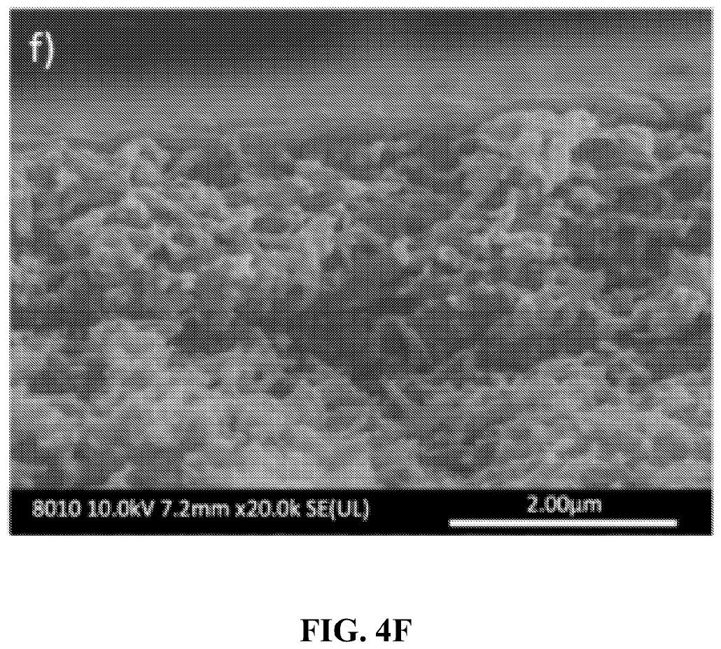

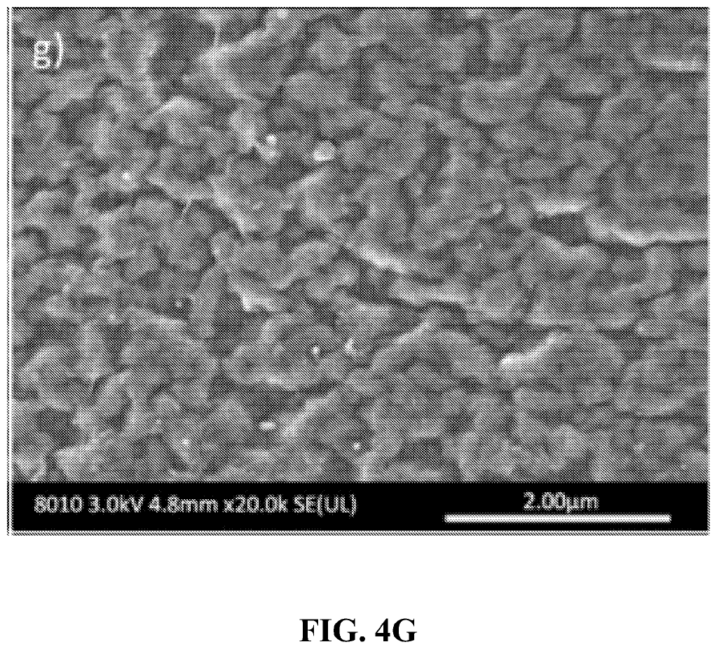

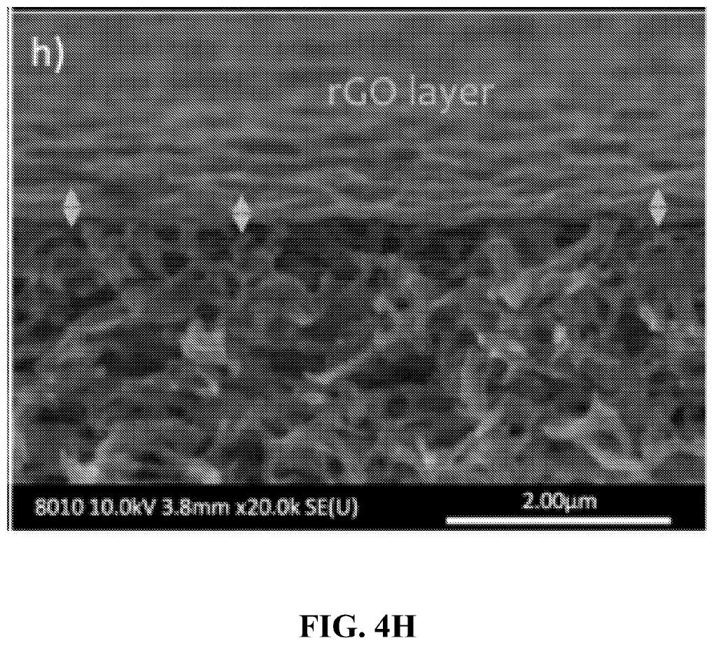

Cross-sectional and top-view images of a bare PES support, and an R2R-rGO membrane (supported on PES) fabricated with the final operating conditions, are shown in FIG. 4. The morphologies before and after hydraulic compaction (under water at 50 bar for 50 hrs) are both shown. Hydraulic compaction occurs naturally when the membranes are first operated with a pressurized feed, and it is useful to account for changes in the morphology before and after this event [17].

As expected, the microstructure of the PES support becomes denser after compaction (FIGS. 4A-4B, 4E-4F) and the support thickness changed from ˜125 μm to ˜65 μm (48% reduction). In addition, compaction resulted in densification of the top surface (FIGS. 4C, 4G), which has an undulated surface topography. Importantly, the thin R2R-rGO membrane (with thickness in the ˜150 nm range) retained its morphology without significant changes (FIGS. 4D, 4H), even as the underlying PES support underwent the expected morphological changes upon compaction. The rGO membrane also shows an undulating topography, conforming to that of the underlying PES support surface.

Given the thin, undulating morphology of the rGO membrane coating, quantitative thickness measurements by SEM are challenging since they are sensitive to the angle (tilt) of the SEM image. However, to obtain a working estimate of the thickness range, a number of images were collected and analyzed with ImageJ 1.53s software (National Institutes of Health, USA). A

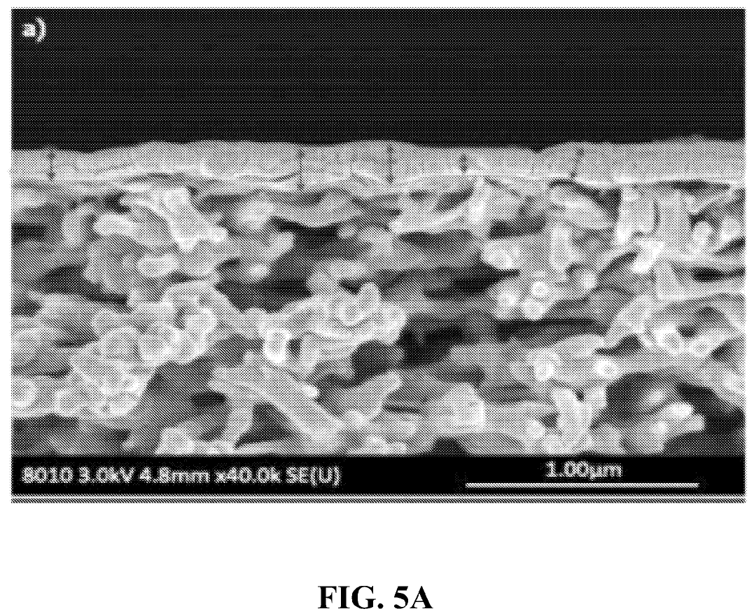

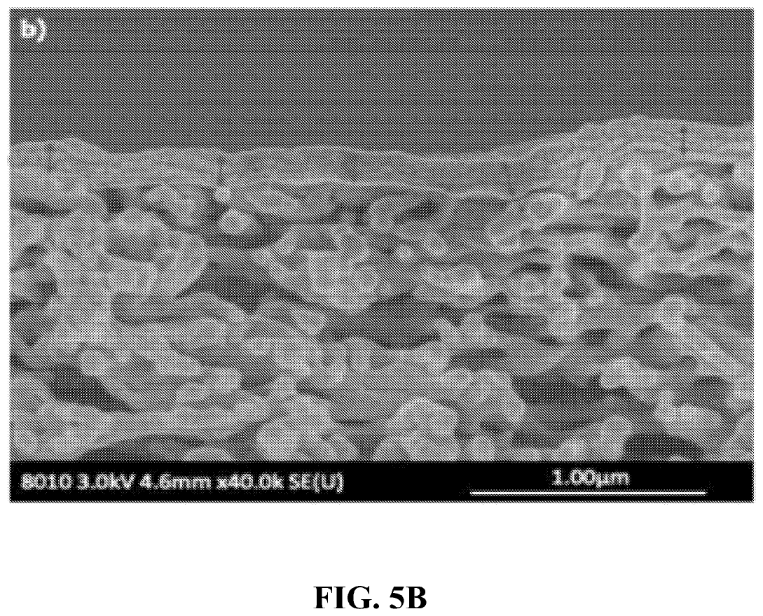

An example is shown in FIGS. 5A-5B, in which freshly-prepared and compacted R2R-rGO membranes were analyzed by ImageJ. The thickness measurements at 10 locations yielded an average thickness of 113±18 nm (freshly prepared) and 127±14 nm (compacted). This is similar to the thickness obtained by static batch mode processing in our previous work [17]. It was observed that although the hydraulic compaction process reduces the PES support thickness by causing a denser microstructure (FIGS. 4A-4B, 4E-4F), it has no statistically significant influence on the thickness of the coated rGO layer on a PES substrate.

However, SEM imaging does not provide a convenient method of evaluating R2R-rGO membrane uniformity over large area. Hence, we also characterized the membrane thickness and uniformity by ellipsometry. Ellipsometric measurements were performed at 48 different locations selected over the entire membrane sheet area (2700 cm²), using a wavelength range of 372-1687 nm at incident angles of 65°, 70°, and 75°. The optical data were analyzed using a combination of the Cauchy model for the porous PES substrate [[41]: Wojciech Ogieglo, Herbert Wormeester, Matthias Wessling, Nieck E. Benes, Spectroscopic Ellipsometry Analysis Of A Thin Film Composite Membrane Consisting Of Polysulfone On A Porous α-Alumina Support, ACS Appl. Mater. Interfaces, (2012), 4, 2, 935-943, https://doi.org/10.1021/am2015958]; [[42]: Wojciech Ogieglo, Jaime A. Idarraga-Mora, Scott M. Husson, Ingo Pinnau, Direct Ellipsometry For Non—Destructive Characterization Of Interfacially-Polymerized Thin-Film Composite Membranes, Journal of Membrane Science, Volume 608, (2020), 118174, ISSN 0376-7388, https://doi.org/101016/j.memsci.2020.118174]and a B-spline model for the rGO coating [[43]: Stefan Schöche, Nina Hong, Mohammadreza Khorasaninejad, Antonio Ambrosio, Emanuele Orabona, Pasqualino Maddalena, Federico Capasso, Optical Properties Of Graphene Oxide And Reduced Graphene Oxide Determined By Spectroscopic Ellipsometry, Applied Surface Science, Volume 421, Part B, (2017), Pages 778-782, ISSN 0169-4332, https://doi.org/10.1016/j.apsusc.2017.01.035] to describe their respective dielectric properties.

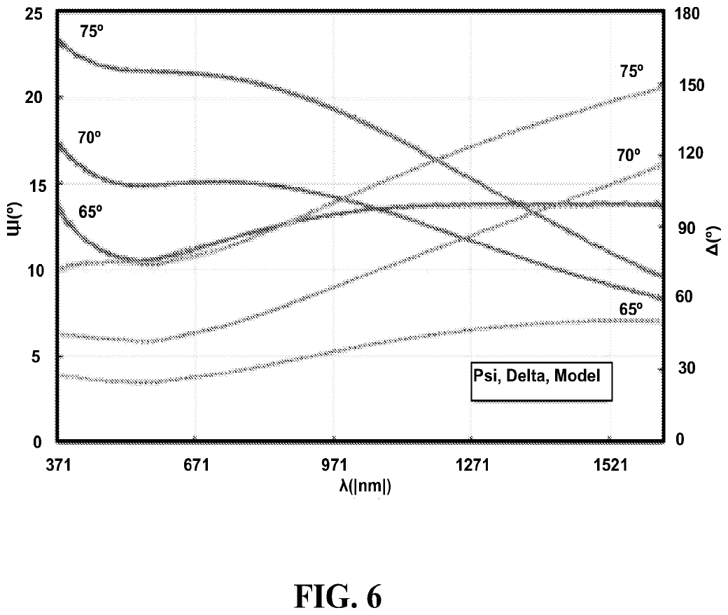

An example from the 720 measurements (48 locations×15 readings per location) measurements is shown in FIG. 6. The extinction coefficients (k) for rGO and porous PES were neglected since both materials are weakly-/non-absorbing dielectrics in the relevant wavelength range [41].

Since the refractive index (n) values for both materials are not extensively reported in the literature, we first tested a range of reasonable values to perform ellipsometric data fitting. The best fits of the reflectance data were obtained using refractive indices of 1.5 (rGO) and 1.45 (porous PES), which were taken as the final values. A different set of values found in the literature (1.5 for rGO and 1.6 for porous PES) [41], [43], and [[44]: Ruben Z. Waldman, Devika Choudhury, David J. Mandia, Jeffrey W. Elam, Paul F. Nealey, Alex B. F. Martinson, Seth B. Darling, Sequential Infiltration Synthesis Of Al₂O₃ In Polyethersulfone Membranes, JOM 71, 212-223, (2019), https://doi.org/10.1007/s11837-018-3142-3] also yielded a comparable fitting quality but with a higher root-mean-square error (RMSE). The overall averages of rGO film thickness, roughness, and RMSE obtained from the R2R-rGO membrane ellipsometric analysis are shown in TABLE 3.

TABLE 3
Ellipsometric Fitting Averages

| | |
|---|---|
| Average Thickness (nm) | 109 ± 25 |
| Roughness (nm) | 18 ± 10 |
| Fit RMSE (nm) | 2 ± 1 |

TABLE 3 shows the statistical average results of the ellipsometry measurements on the R2R-rGO membrane. Refractive indices were taken as n_{rGO}=1.5 and n_{PES}=1.45.

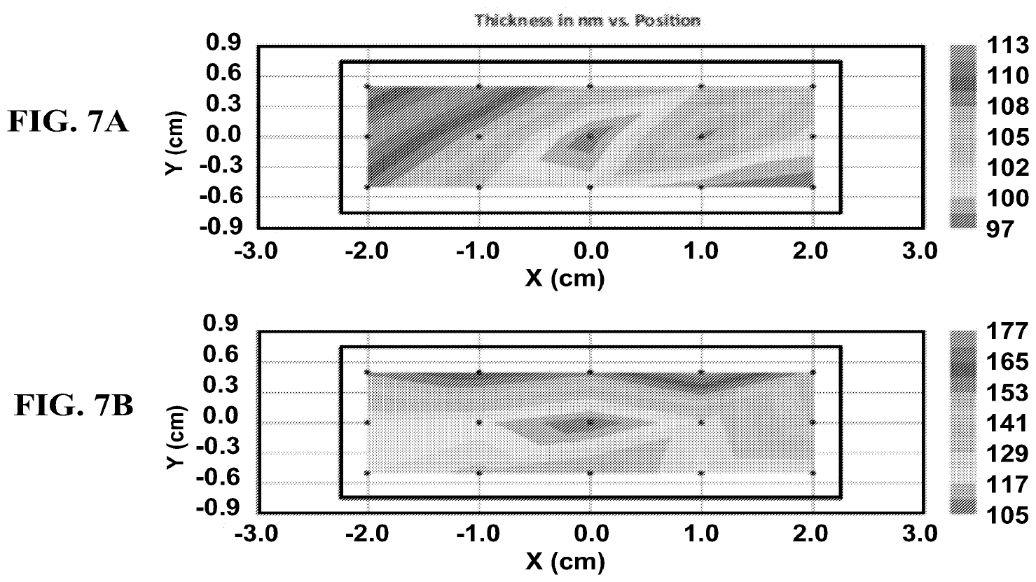

The average thickness obtained over a large area of the membrane is quite similar that measured by SEM in a few specific locations (discussed earlier). Typical thickness maps (4×1 cm each) from two of the 48 such locations analyzed are shown in FIGS. 7A-7B. While the maps clearly indicate the presence of the rGO coating across the entire area, various features such as “hills and valleys” (i.e., regions of thicker and thinner coating ranging from 90-180 nm) and localized spots of lower coating thickness (<100 nm) can be seen. These differences in the thickness of the coated rGO layer cannot be observed by the naked eye, and are not considered as membrane defects.

However, it should be mentioned that any disruption or disturbance such as sudden movement of the vacuum platen, delay in pumping the coating material (rGO solution) to the slot-die, and changes in the speed of the carrier layer (coating speed) in the process of R2R coating, can cause actual defects including ribbing, rivulets and air entrainment on the quality of the final coating [[45]: Xiaoyu Ding, Jianhua Liu, Tequila A. L. Harris, A Review Of The Operating Limits In Slot-die coating Processes, AIChE J., (2016), 62: 2508-2524, https://doi.org/10.1002/aic.15268]. Minimizing these effects will be important during large-scale fabrication of rGO membranes. It is believed that this can be achieved by minimizing disruptions and disturbances that can be controlled, in addition to ensuring the quality of the materials and tooling.

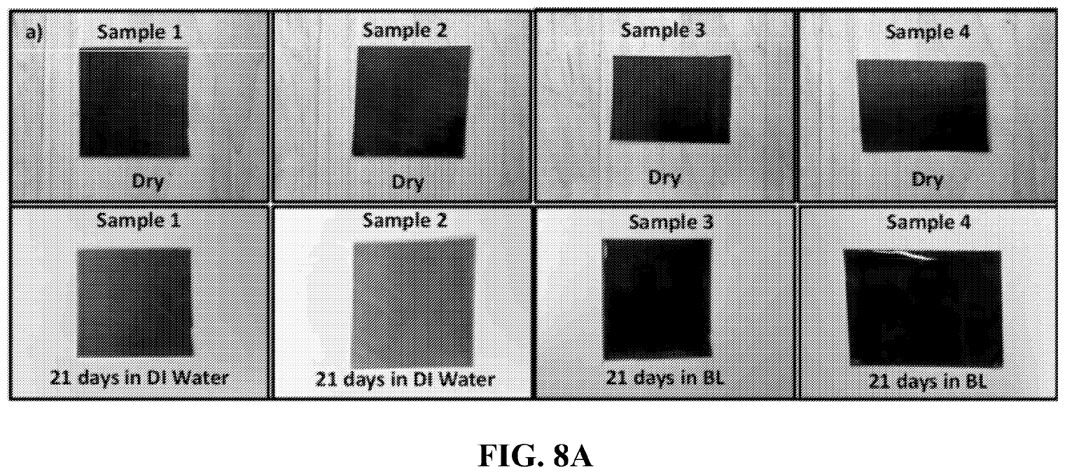

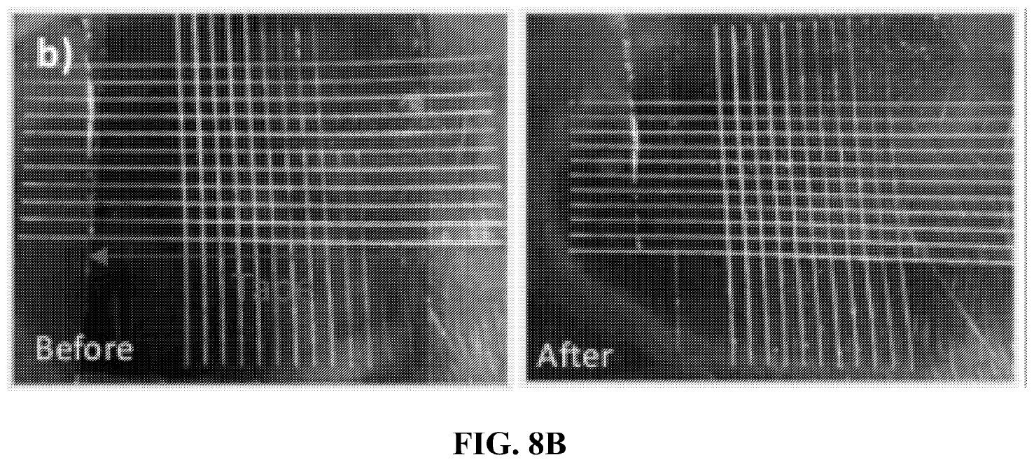

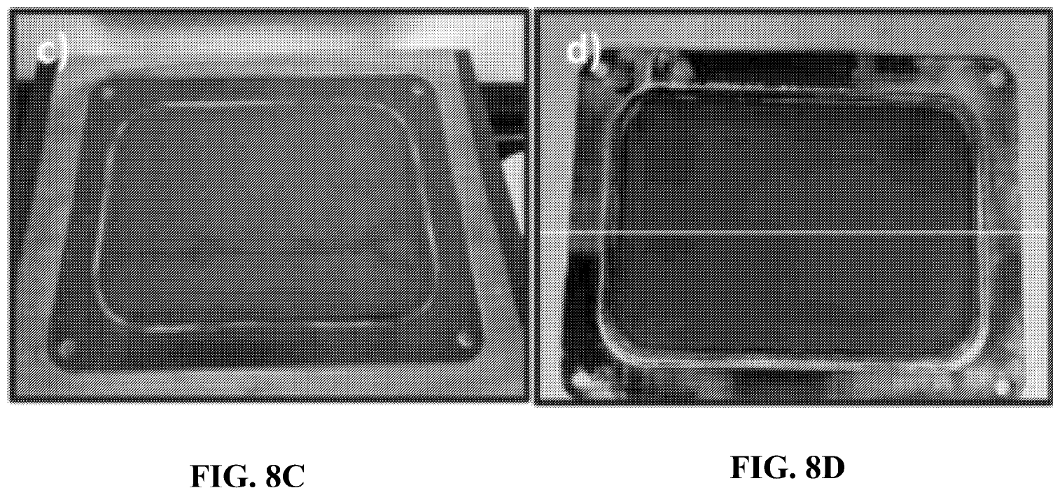

The mechanical and chemical stabilities of the R2R-rGO membranes were qualitatively determined by the ASTM D3359 peel test [[46]: ASTM, Standard Test Methods for Rating Adhesion by Tape Test, (2022), https://www.astm.org/d3359-23.html] and by submerging the membranes in water and BL. The as-made (non-compacted) rGO membranes showed no sign of delamination after being submerged in DI water and in BL for three weeks at ambient temperature, e.g., 25° C., (FIG. 8A). Illustrated in FIG. 8B are the ASTM peel test results on the as-made membranes, where a rating of 4 (only trace peeling or removal) within the 0-5 scale is indicated.

Further confirmation of the excellent stability of the R2R-rGO membranes is shown in FIGS. 8C-8D, wherein there was no sign of delamination or other surface defects after 50 hrs of water compaction at 50 bar and 25° C., and after 310 hrs of operation in BL at 50 bar and 72° C., respectively.

The R2R-rGO membranes show the same stability characteristics as those of static-fabricated rGO membranes discussed in our prior work [17], which showed that a combination of chemical reduction and hydraulic conditioning led to rGO membranes with high chemical and mechanical stability. While the fundamental reasons for this behavior are not fully understood, it is thought that the reduction of GO increases the content of the hydrophobic graphene-like (G) domains within the nanosheets that increase the inter-sheet interactions and prevent swelling or delamination. Additionally, compaction under hydraulic pressure is hypothesized to result in further efficient packing/arrangement of the rGO sheets, enhancing mechanical stability.

In contrast, GO membranes containing much larger hydrophilic (oxygen functionalized) regions generally have much lower stability in water due to the swelling of interlayer spaces by water [[47]: Che-Ning Yeh, Kalyan Raidongia, Jiaojing Shao, Quan-Hong Yang Jiaxing Huang, On The Origin Of The Stability Of Graphene Oxide Membranes In Water, Nature Chem 7, 166-170, (2015), https://doi.org/10.1038/nchem.2145].

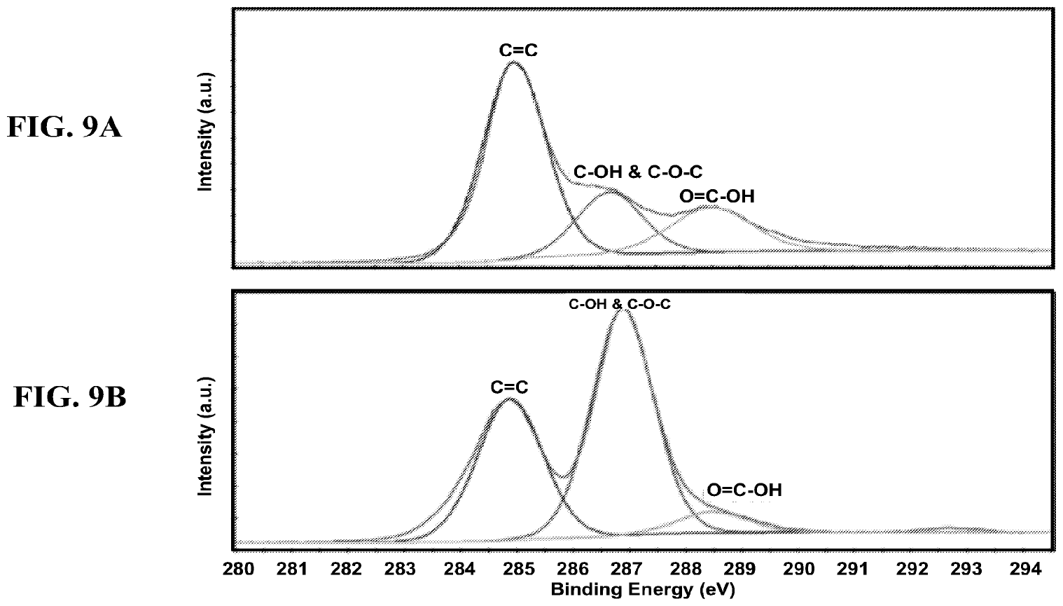

The XPS C1s spectrum of FIG. 9A shows the three types of carbon environments in the R2R-rGO membrane: C═C bonding (corresponding to the hydrophobic 2D graphene lattice of the rGO nanosheet), C—O—C and C—OH bonding (functionalization of the graphene lattice by hydrophilic epoxy and hydroxyl groups), and O═C—OH bonding (functionalization of the nanosheet edges by hydrophilic carboxyl groups). In comparison, FIG. 9B shows a considerably higher quantity of hydrophilic domains in the originally synthesized GO material before chemical reduction. These spectra are well consistent with our previous work on static batch rGO membranes [17] and confirm that the dynamically fabricated rGO membranes have the same chemical composition.

We conducted detailed membrane permeation measurements on the R2R-rGO membranes. A rectangular sheet of ˜265 cm² area (18.9×14 cm) was cut from a ˜2700 cm² (˜90×30 cm) R2R-rGO membrane sheet and mounted in a crossflow permeation cell (see FIG. 8C). Long-term crossflow permeation measurements were performed in a real BL feed at 72° C. and 5.6 L/min feed flow rate (which leads to a 0.55 m/s BL feed velocity over the membrane), with repeated cycling over a TMP range of 10-50 bar. The total time on-stream of the membrane during this measurement was 500 hrs (21 days).

This measurement scheme is similar to that performed for our previous static batch mode fabricated rGO membranes [17], except that the currently available softwood BL used in this work is from a different mill and hence has minor differences in composition. A first cycle (conditioning cycle) of operation at 10-50 TMP was carried out to stabilize the fluxes. As with static batch mode fabricated rGO membranes [17], the second cycle (production cycle) was used to measure the steady-state fluxes for the R2R-rGO membrane at each TMP.

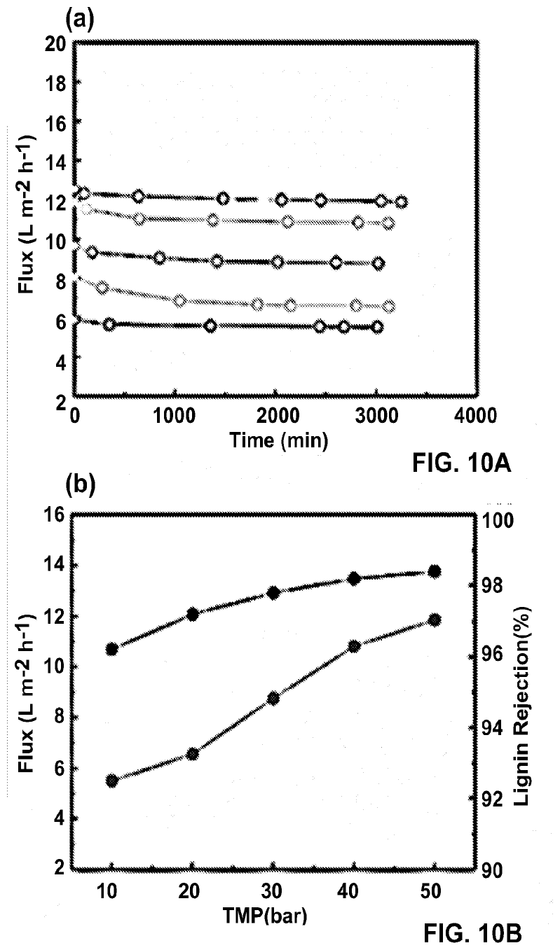

The steady-state fluxes increase with TMP as expected (FIGS. 10A-10B). The steady-state permeate fluxes and lignin rejections obtained at each TMP in cycle 1 and cycle 2 are shown in FIG. 10B. The membrane shows excellent lignin rejection (98.3% at 50 bar) similar to our previous data for rGO membranes fabricated using the static batch mode. The R2R-rGO membrane exhibits steady and robust/long-lived operation over 500 hrs, confirming its high quality.

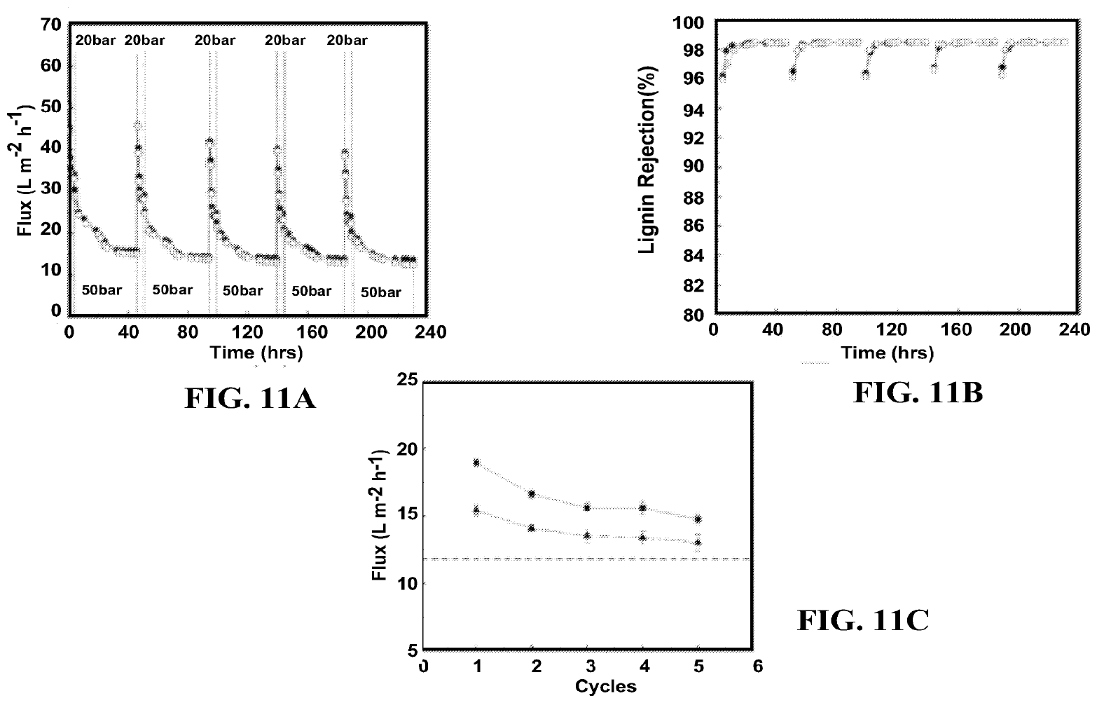

Next, we investigated the effect of periodic depressurization and concurrent water flushing on the R2R-rGO membrane. These procedures are similar to those used in industrial membrane operations to periodically remove any reversible fouling layers that will inevitably accumulate on the membrane surface, hence increasing the overall membrane throughput during the time intervals between the flushing operation. Two freshly-fabricated R2R-rGO membranes were tested. The flux behavior in 5 cycles of water flushing and operation in BL feed are given in FIG. 11A. In each cycle (referred to here as a wash-operate cycle), the membrane is flushed with water at 20 bar and 72° C. for 4 hrs, followed by normal operation in BL feed at 50 bar and 72° C. until steady state is reached (about 40 hrs). The lignin rejection values as a function of time during the operate portion of each cycle are given in FIG. 11B.

FIG. 11C summarizes the steady-state and average permeate production fluxes from the BL operation duration of each cycle, as obtained by using the data in FIG. 11A. In this case, the values of the two membranes in the same cycle are averaged to a single value, and the small difference in the individual values is shown as an error bar.

Overall, the two independently fabricated membranes exhibit practically identical behavior, which indicates the reliability and reproducibility of the R2R fabrication method developed in this work. Periodic water flushing (along with depressurization to 20 bar) is effective in providing increases in average flux during BL operation, over and above the steady-state value. No membrane mechanical stability issues are seen as a result of the depressurization and switching from BL to water. The steady-state and average production fluxes stabilize over the first three wash-operate cycles. The lignin rejections maintain excellent stability throughout the five cycles.

In a real membrane module (such as spiral wound or tubular), the solids concentration of the BL on the feed side would continuously increase as it travels from the inlet (15 wt % solids) to the exit (25-30 wt % solids), due to water removal by permeation through the rGO membrane. Since the permeate flux will be a strong function of the solids content in the BL feed, the overall performance of the module will be an average over the range of BL solids concentration as it passes through the module.

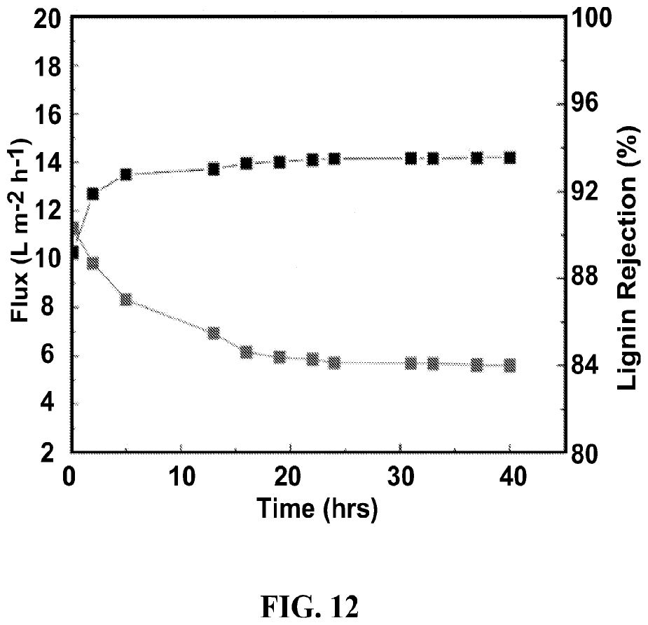

To evaluate this effect, we prepared a concentrated BL (26.2 wt % solids) by evaporating water from the original BL (15.7 wt % solids), and operated one of the R2R-rGO membranes in this concentrated BL feed at 72° C. As shown in FIG. 12, the membrane shows an average flux of 6.7 LMH over 40 hrs of operation and a steady-state and steady-state apparent lignin rejection of 94% at 50 bar, which (as expected) are lower than those obtained from 15.7 wt % solids BL. This decrease is mainly due to the increased concentration polarization layer on the membrane surface caused by the higher solids concentration. As a result, the concentration polarization resistance has a much larger contribution to the flux and the apparent rejection (which is calculated based on the bulk-phase lignin concentration in the feed). Data collected at conditions corresponding both to the inlet and outlet concentrations of the BL streams is useful for a more accurate estimation of the required membrane area in process modeling and technoeconomic analysis, as has been performed in our recent work based on data collected with rGO membranes processed using the static batch mode [15].

We have demonstrated a scalable, aqueous-phase continuous fabrication method for rGO-based NF membranes by slot-die coating on a R2R with integrated vacuum filtration. We successfully fabricated high-quality 90×30 cm rGO membranes supported on porous PES sheets. These membranes were characterized in more detail by SEM, ellipsometry, and XPS to determine their uniformity and chemical composition.

Extensive crossflow NF experiments with kraft black liquor (BL) feeds highlight the excellent chemical and mechanical stability of these membranes in harsh conditions (temperature of 72° C. and pH ˜13) as well as their high lignin retention performance. These dynamically fabricated R2R-rGO membranes retained the same flux, lignin rejection, and stability properties as those fabricated previously using a static batch mode vacuum filtration process. The flexibility combination of slot-die coating and vacuum allows completely aqueous-phase (free of organic solvents and VOCs) continuous fabrication of rGO membranes. As a result, polymeric and non-polymeric substrates that are sensitive to organic solvents can be used to fabricate rGO membranes. The present membranes are ˜100 nm thin, but there appears no barrier to fabrication of even thinner GO-based membranes with this method.

While certain examples of this disclosure have been described in connection with what is presently considered to be the most practical and various examples, it is to be understood that this disclosure is not to be limited to the disclosed examples, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain examples of the technology and also to enable any person skilled in the art to practice certain examples of this technology, including making and using any apparatuses or systems and performing any incorporated methods. The patentable scope of certain examples of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method comprising:
coating a carbon-based nanomaterial (CBN) suspension on a porous substrate; and
vacuum processing the CBN suspension and the porous substrate.

2. The method of claim 1, wherein:
the coating comprises coating with a coater;
the vacuum processing comprises vacuum processing with a vacuum; and
relative motion between the coater, the porous substrate, and the vacuum provide for forming a continuous feed of a CBN membrane by a continuous coating of the CBN suspension on the porous substrate and the vacuum processing of the CBN suspension and the porous substrate.

3. (canceled)

4. The method of claim 2, wherein:
at least one of the coating, the porous substrate, or the vacuum processing is stationary; and
the CBN is selected from the group consisting of graphene oxide (GO), reduced graphene oxide (rGO), holey graphene oxide (hGO), and a combination thereof.

5. The method of claim 4, wherein:
the method is a method of fabricating a CBN suspension membrane; and
the fabricating comprises a completely aqueous-phase continuous fabricating.

6. The method of claim 5 further comprising:
continuously supplying a carrier in a roll-to-roll (R2R) manner; and
forming a continuous feed of a CBN membrane comprising the porous substrate and the coated CBN suspension in a form of a non-crosslinked CBN coating formed with vacuum assist from the vacuum processing;
wherein the coating comprises slot-die coating the CBN suspension having a CBN suspension concentration across a coating gap and at a CBN suspension flow rate on a top surface of a porous substrate.

7. The method of claim 6, wherein the CBN membrane has at least one of:
a CBN membrane effective area of greater than 645 mm²;
a CBN membrane thickness of between 10 nm and 1000 nm;
a CBN membrane defect profile of nonuniformity in a thickness direction of less than 10%;
a CBN membrane defect profile of a delamination of less than 10%;
a CBN membrane defect profile of streaks or rivulets of less than 10%;
a CBN membrane defect profile of an air entrainment of less than 10%;
a CBN membrane defect profile of ribbing or waviness in a machine direction web that do not break through to the porous substrate of less than 10%; or
a CBN membrane defect profile of barring or waviness across a machine direction web of the porous substrate of less than 10%.

8. The method of claim 1, wherein:
the vacuum processing comprises vacuum processing the CBN suspension, one or more additives, and the porous substrate; and
the coating is one of:
a co-processing of the CBN suspension and the one or more additives; or
a simultaneous processing of the CBN suspension and the one or more additives.

9. The method of claim 8, wherein:
the co-processing of the CBN suspension and the one or more additives comprises:
slot-die coating, from one of two tandem slot-dies of a slot-die, the CBN suspension free of the one or more additives on the porous substrate; and
slot-die coating, from the other of the two tandem slot-dies of the slot-die, the one or more additives on the porous substrate; and
the simultaneous processing of the CBN suspension and the one or more additives comprises:
slot-die coating, from one layer of a dual layer slot-die, the CBN suspension free of the one or more additives on the porous substrate; and
slot-die coating, from the other layer of the dual layer slot-die, the one or more additives on the GO or rGO suspension.

10.-14. (canceled)

15. A carbon-based nanomaterial (CBN) suspension membrane fabricated by the method of claim 7.

16. The method of claim 1, wherein:
the coating comprises slot-die coating the CBN suspension on the porous substrate; and
the vacuum processing comprises vacuum processing the CBN suspension, one or more additives, and the porous substrate.

17. The method of claim 16, wherein at least one of:
the CBN suspension is an aqueous CBN suspension;
the CBN is selected from the group consisting of GO, rGO, hGO, and a combination thereof;
the CBN suspension is an aqueous CBN suspension comprising the one or more additives;
the CBN suspension is free of organic solvents and volatile organic compounds (VOCs);
the method is a method of fabricating that comprises a completely aqueous-phase continuous fabricating; or
the method is a method of fabricating that is a continuous fabricating, free of organic solvents and VOCs.

18.-34. (canceled)

35. The method of claim 1, wherein:
the CBN suspension is a suspension of graphene oxide (GO) or reduced graphene oxide (rGO); and
the method further comprises forming a continuous feed of a GO or rGO membrane comprising the porous substrate and the coated GO or rGO suspension in a form of a non-crosslinked GO or rGO coating comprising one or more additives.

36. (canceled)

37. The method of claim 35, wherein:
the coating comprises slot-die coating the GO or rGO suspension on the porous substrate; and
the method further comprises providing the one or more additives to the slot-die coated GO or rGO suspension on the porous substrate.

38. (canceled)

39. The method of claim 37, wherein:
the GO or rGO suspension is an aqueous GO or rGO suspension free of organic solvents and volatile organic compounds (VOCs);
the method is a method of fabricating suspensions of the GO or rGO and is a completely aqueous-phase continuous fabricating, free of organic solvents and VOCs;
relative motion between the slot-die coating, the porous substrate, and the vacuum processing provide for the continuous slot-die coating of the GO or rGO suspension on the porous substrate and the vacuum processing the GO or rGO suspension and the porous substrate; and
wherein at least one of the slot-die coating, the porous substrate, or the vacuum processing is stationary.

40. (canceled)

41. The method of claim 39, wherein:
the fabricated GO or rGO membrane has a GO or rGO membrane effective area, a GO or rGO membrane thickness, and a GO or rGO membrane defect profile;
the GO or rGO membrane effective area is greater than 645 mm; and
the GO or rGO membrane thickness is between 10 nm and 1000 nm.

42. The method of claim 41, wherein:
the GO or rGO membrane defect profile includes at least one defect characteristic selected from the group consisting of nonuniformity, delamination, streaks, rivulets, air entrainment, ribbing, barring, waviness, and combinations thereof; and
the GO or rGO membrane has at least one of:
a nonuniformity defect characteristic in a thickness direction of less than 10%;
a streaks or rivulets defect characteristic of less than 10%;
an air entrainment defect characteristic of less than 10%;
a ribbing or waviness defect characteristic in a machine direction web that do not break through to the porous substrate of less than 10%; or
a barring or waviness defect characteristic across a machine direction web of the porous substrate of less than 10%.

43.-45. (canceled)

46. The method of claim 35, wherein the coating is a co-processing of the GO or rGO suspension and the one or more additives comprising:
slot-die coating, from one of two tandem slot-dies of a slot-die, the GO or rGO suspension free of the one or more additives on the porous substrate; and
slot-die coating, from the other of the two tandem slot-dies of the slot-die, the one or more additives on the porous substrate.

47. The method of claim 35, wherein the coating is a simultaneous processing of the GO or rGO suspension and the one or more additives comprising:
slot-die coating, from one layer of a dual layer slot-die, the GO or rGO suspension free of the one or more additives on the porous substrate; and
slot-die coating, from the other layer of the dual layer slot-die, the one or more additives on the GO or rGO suspension.

48. A membrane fabricated by the method of claim 46.

49. The method of claim 1, wherein:
the CBN suspension is a GO material suspension; and
the method is a method of GO material membrane roll-to-roll (R2R) fabrication.

50.-61. (canceled)

62. A membrane fabricated by the method of claim 47.

63. A system for GO material membrane fabrication comprising:
a coater;
a porous substrate; and
a vacuum;
wherein the coater is configured to coat a GO material suspension on the porous substrate;
wherein the system is configured to fabricate a continuous feed of the GO material membrane comprising the porous substrate and the coated GO material suspension in a form of a non-crosslinked GO material coating formed with vacuum assist from the vacuum.

64. (canceled)

65. The system of claim 63, wherein:
the system is further configured for completely aqueous-phase continuous fabricating;
relative motion between the coater and the porous substrate provide for a continuous coat of the GO material suspension on the porous substrate;
the coater is a slot-die coater configured to apply the GO material suspension across a coating gap and at a GO material suspension flow rate on a top surface of the porous substrate, the GO material suspension having a GO material suspension concentration; and
the vacuum supports a bottom surface of the porous substrate, the vacuum configured to apply a vacuum to the porous substrate to vacuum secure the porous substrate to the vacuum and fabricate the GO material membrane from the non-crosslinked GO material coating and the porous substrate.

66. The system of claim 65 further comprising:
a moving carrier;
wherein the porous substrate is configured to move in a substrate direction at a substrate speed; and
wherein the moving carrier is configured to carry the vacuum such that the vacuum secured porous substrate moves in the substrate direction at the substrate speed.

67.-71. (canceled)

72. A system for fabricating suspensions of graphene oxide (GO) or reduced graphene oxide (rGO) into membranes comprising:
a porous substrate;
one or more containers configured to contain a GO or rGO suspension and one or more additives;
a slot-die coater configured to apply the GO or rGO suspension across a coating gap and at a GO or rGO suspension flow rate on a top surface of the substrate, the GO or rGO suspension having a GO or rGO suspension concentration;
one or more transport assemblies configured to supply the GO or rGO suspension and the one or more additives from the container to the slot-die coater; and
a vacuum assembly upon which a bottom surface of the porous substrate is supported, the vacuum assembly configured to apply a vacuum to the porous substrate to vacuum secure the porous substrate to the vacuum assembly and fabricate a GO or rGO membrane from the GO or rGO suspension and the porous substrate;
wherein:
the slot-die coater is a slot-die coater having two tandem slot-dies, wherein the GO or rGO suspension is applied from one of two tandem slot-dies, and wherein the one or more additives is applied from the other one of the two tandem slot-dies; or
the slot-die coater is a dual laver slot-die coater, wherein the GO or rGO suspension is applied from one of layers of the dual layer slot-die coater, and wherein the one or more additives is applied from the other one of the layers of the dual laver slot-die coater.

73.-74. (canceled)
